(19) United States
(12) Patent Application Publication
(10) Pub. No.: US 2025/0323568 A1
(43) Pub. Date: Oct. 16, 2025

(54) SWITCHING CONTROL CIRCUIT AND POWER SUPPLY CIRCUIT

(71) Applicant: FUJI ELECTRIC CO., LTD., Kawasaki-shi (JP)

(72) Inventor: Ryoma KAMAKURA, Matsumoto-city (JP)

(73) Assignee: FUJI ELECTRIC CO., LTD., Kawasaki-shi (JP)

(21) Appl. No.: 19/060,123

(22) Filed: Feb. 21, 2025

(30) Foreign Application Priority Data
Apr. 15, 2024 (JP) 2024-065763

(51) Int. Cl. H02M 1/42; H02M 1/00; H02M 7/217

(52) U.S. Cl. CPC H02M 1/4225; H02M 1/0009; H02M 7/217

(57) ABSTRACT

A switching control circuit for a power supply circuit including a first inductor, a first transistor, a second inductor, and a second transistor. The switching control circuit includes: a first driver circuit turning off the first transistor, in response to a first time period corresponding to an output voltage of the power supply circuit having elapsed since the first transistor has been turned on after a first inductor current reaches a first value; an output circuit outputting a signal indicating a half period of a switching period of the first transistor; and a second driver circuit turning on the second transistor, in response to a signal indicating the half period after turning on of the first transistor and the second inductor current reaching a second value, and turning off the second transistor, in response to a second time period corresponding to the output voltage having elapsed.

### CROSS-REFERENCE TO RELATED APPLICATIONS

The present application claims priority pursuant to 35 U.S.C. § 119 from Japanese patent application number 2024-065763 filed on Apr. 15, 2024, the entire disclosure of which is hereby incorporated by reference herein.

### BACKGROUND

### Technical Field

The present disclosure relates to a switching control circuit and a power supply circuit.

### Description of the Related Art

Typical power factor correction circuits (hereinafter, referred to as power factor correction (PFC) circuits) that operate in a critical mode improve a power factor by shaping the waveform of the peak values of an inductor current flowing through an inductor into a waveform similar to that of a rectified voltage obtained by rectifying an alternating current (AC) voltage. Further, such a power factor correction circuit may include multiple boost chopper circuits (e.g., of two systems) (e. g., Japanese patent application publication Nos. 2022-037532, 2020-129865, 2020-039235, 2017-070193, 2015-019558, 2014-155240, 2011-030311, 2011-030310, 2010-130896, 2010-035271, 2010-035270, 2007-181342, 2007-181252, 2007-043875, 2007-043807, 2007-043787, 2007-043786, 2007-028753, 2007-028729, 2007-020252, 2007-014139, 2005-045996, 2005-045995).

Incidentally, a PFC circuit may cause boost chopper circuits of two systems to operate in parallel (hereinafter referred to as an interleaved operation as appropriate).

However, when the boost chopper circuits of two system are operated in parallel, the switching periods of two transistors that constitute the boost chopper circuit may become unstable, in response to fluctuations occurring in the output of a full-wave rectifier circuit, for example. As a result, the phase difference in the on timing of the two transistors constituting the boost chopper circuits of the two systems may shift from a predetermined phase difference (e.g., 180°).

### SUMMARY

A first aspect of the present disclosure is a switching control circuit for a power supply circuit, the power supply circuit including a first circuit that includes: a first inductor configured to receive a voltage corresponding to an alternating current (AC) voltage, and a first transistor configured to control a first inductor current flowing through the first inductor, a second circuit that includes: a second inductor configured to receive the voltage corresponding to the AC voltage, and a second transistor configured to control a second inductor current flowing through the second inductor, and an output terminal to which the first circuit, the second circuit, and a load are connected, the power supply circuit being configured to generate an output voltage of a target level at the output terminal from the AC voltage inputted thereto, the switching control circuit being configured to control switching of the first transistor and the second transistor, the switching control circuit comprising: a first driver circuit configured to turn off the first transistor, in response to a first time period corresponding to the output voltage having elapsed since the first transistor has been turned on after the first inductor current reaches a first value; an output circuit configured to output a signal indicating a half period of a switching period of the first transistor; and a second driver circuit configured to turn on the second transistor, in response to the signal indicating the half period after turning on of the first transistor, and the second inductor current reaching a second value, and turn off the second transistor, in response to a second time period corresponding to the output voltage having elapsed.

A second aspect of the present disclosure is a power supply circuit configured to generate an output voltage at a target level from an alternating current (AC) voltage inputted thereto, the power supply circuit comprising: a first circuit that includes: a first inductor configured to receive a voltage corresponding to the AC voltage, and a first transistor configured to control a first inductor current flowing through the first inductor; a second circuit that includes: a second inductor configured to receive the voltage corresponding to the AC voltage, and a second transistor configured to control a second inductor current flowing through the second inductor; an output terminal to which the first circuit, the second circuit, and a load are connected, and through which the generated output voltage is outputted; and a switching control circuit configured to control switching of the first transistor and the second transistor, the switching control circuit including a first driver circuit configured to turn off the first transistor, in response to a first time period corresponding to the output voltage having elapsed since the first transistor has been turned on after the first inductor current reaches a first value, an output circuit configured to output a signal indicating a half period of a switching period of the first transistor, and a second driver circuit configured to turn on the second transistor, in response to the signal indicating the half period after turning on of the first transistor, and the second inductor current reaching a second value, and turn off the second transistor, in response to a second time period corresponding to the output voltage having elapsed.

### BRIEF DESCRIPTION OF THE DRAWINGS

FIG. 1 is a diagram illustrating an example of an AC-DC converter 10.

FIG. 2A illustrates an example of an input line filter 20.

FIG. 2B is a diagram illustrating an example of an input line filter 20 in which a parasitic component is taken into account.

FIG. 3 is a diagram illustrating an example of a power factor correction IC 25.

FIG. 4 is a diagram illustrating an example of a switching control circuit 203a.

FIG. 5 is a diagram illustrating an operation example of a switching control circuit 203a.

FIG. 6 is a diagram illustrating main waveforms of an AC-DC converter 10.

FIG. 7 is a diagram illustrating an operation example of a switching control circuit 203a.

FIG. 8 is a diagram illustrating a flowchart example of an operation of a switching control circuit 203a.

FIG. 9 is a diagram illustrating an operation example of a switching control circuit 203a.

FIG. 10 is a diagram illustrating a flowchart example of an operation of a switching control circuit 203a.

FIG. 11 is a diagram illustrating an example of a switching control circuit 203b.

FIG. 12 is a diagram illustrating an operation example of a switching control circuit 203b.

FIG. 13 is a diagram illustrating an operation example of a switching control circuit 203b.

FIG. 14 is a diagram illustrating a flowchart example of an operation of a switching control circuit 203b.

FIG. 15 is a diagram illustrating an example of a switching control circuit 203c.

FIG. 16 is a diagram illustrating an operation example of a switching control circuit 203c.

FIG. 17 is a diagram illustrating a flowchart example of an operation of a switching control circuit 203c.

FIG. 18 is a diagram illustrating an example of a switching control circuit 203d.

FIG. 19 is a diagram illustrating an operation example of a switching control circuit 203d.

FIG. 20 is a diagram illustrating an operation example of a switching control circuit 203d.

FIG. 21 is a diagram illustrating a flowchart example of an operation of a switching control circuit 203d.

### DETAILED DESCRIPTION

At least following matters will become apparent from the descriptions of the present description and the accompanying drawings. It is assumed, hereinafter, that a “circuit” according to an embodiment of the present disclosure includes not only an analog circuit and a logic circuit of a wired logic type, but also a functional block (or means) that is included in a digital signal processor (DSP), a microcomputer, or the like, and that is capable of executing digital arithmetic processing.

Embodiments of the present disclosure will be described below with reference to the drawings. The same or equivalent constituent elements, members, and the like illustrated in the drawings are given the same reference numerals, and repetitive description is omitted as appropriate.

### EMBODIMENTS

### Overview of AC-DC Converter 10

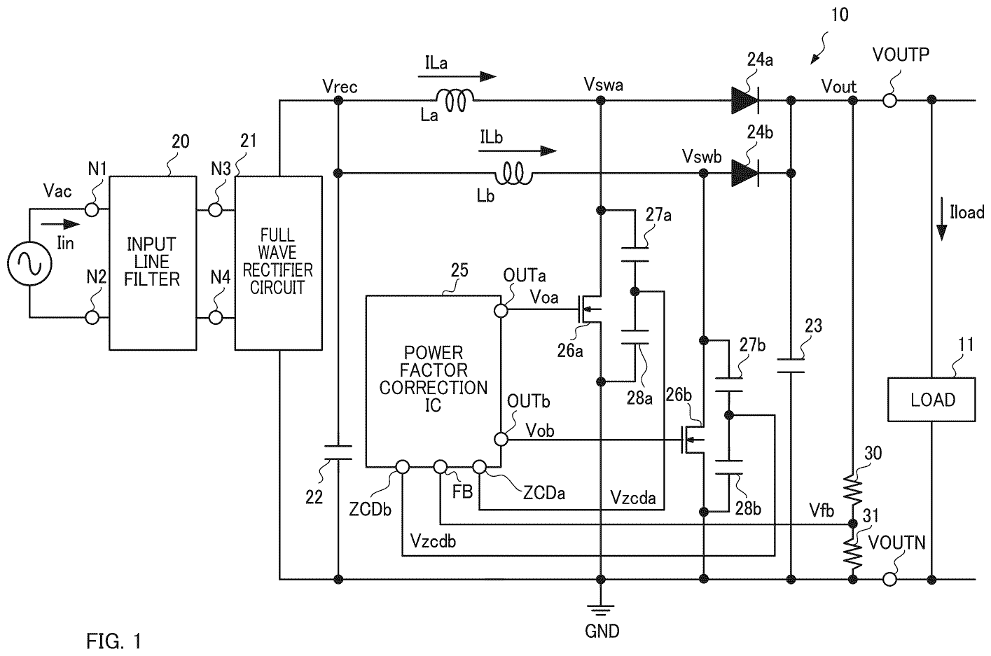

FIG. 1 is a diagram illustrating a configuration of an AC-DC converter 10 which is an embodiment of the present disclosure. The AC-DC converter 10 is a boost power factor correction (PFC) circuit to generate an output voltage Vout of a target level at an output terminal VOUTP from an alternating-current (AC) voltage Vac of a commercial power supply. Further, the AC-DC the converter 10 outputs an output voltage Vout to a load 11 through the output terminal VOUTP. An output terminal VOUTN is grounded.

The AC-DC converter 10 includes an input line filter 20, a full-wave rectifier circuit 21, capacitors 22, 23, coils La, Lb, diodes 24a, 24b, a power factor correction IC 25, N-channel metal-oxide-semiconductor (NMOS) transistors 26a, 26b, capacitors 27a, 27b, 28a, 28b, and resistors 30, 31. Note that the AC-DC converter 10 corresponds to a “power supply circuit”.

The input line filter 20 attenuates both the noise from the AC power supply (e.g., nodes N1, N2) side and the noise from the AC-DC converter 10 (e.g., nodes N3, N4) side. The AC voltage Vac is applied to the nodes N1, N2 of the input line filter 20. Then, the input line filter 20 applies the AC voltage Vac with the nose attenuated, to the nodes N3, N4.

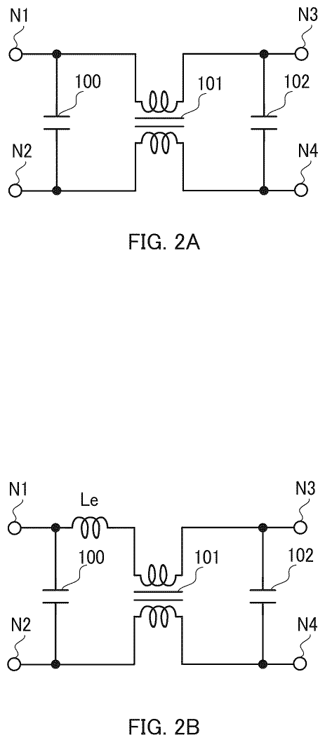

The input line filter 20 includes capacitors 100, 102, and a common mode coil 101, as illustrated in FIG. 2A. With such a configuration, the input line filter 20 can attenuate both so-called common mode noise and differential noise.

Specifically, the input line filter 20 attenuates common mode noise with the common mode coil 101. Meanwhile, the input line filter 20 attenuates differential noise from the AC power supply side with the capacitor 100, and attenuates differential noise from the AC-DC converter 10 side with the capacitor 102.

However, as illustrated in FIG. 2B, the actual common mode coil 101 has a stray inductance Le as a parasitic component. Furthermore, this stray inductance Le constitutes an LC resonant circuit together with the capacitor 100 or 102. If resonance occurs between the stray inductance Le and the capacitor 102, the voltage between the nodes N3 and N4 will fluctuate, in a period corresponding to the resonant frequency. As a result, the output voltage of the full-wave rectifier circuit 21 (described later) fluctuates.

The full-wave rectifier circuit 21 of FIG. 1 full-wave rectifies the predetermined AC voltage Vac inputted thereto, and outputs a resultant voltage, as a voltage Vrec, to the capacitor 22 and the coils La, Lb. Note that the AC voltage Vac is a voltage with an effective value in a range of 100 to 240 V and a frequency in a range of 50 to 60 Hz, for example. Hereinafter, in an embodiment of the present disclosure, voltages basically refer to a difference in potential with respect to a reference point (GND in FIG. 1), however, the AC voltage Vac refers to a voltage between terminals.

The capacitor 22 smooths the input voltage Vrec, and the capacitor 23 is an element to be charged with the output voltages of two boost chopper circuits. The coil La, the diode 24a, and the NMOS transistor 26a configure a “boost chopper circuit of a first system” together with the capacitor 23. Further, the coil Lb, the diode 24b, and the NMOS transistor 26b configure a “boost chopper circuit of a second system” together with the capacitor 23. Thus, the charge voltage of the capacitor 23 results in the output voltage Vout of a direct current (DC). Note that the boost chopper circuit of the first system corresponds to a “first circuit,” and the boost chopper circuit of the second system corresponds to a “second circuit”.

Further, it is assumed that when an inductor current ILa flows through the coil La in the direction of an arrow, the direction in which the inductor current ILa flows is a positive direction, and when the inductor current ILa flows in the direction opposite to the direction of the arrow, the direction in which the inductor current ILa flows is a negative direction. Note that the coil La corresponds to a “first inductor”.

Further, it is assumed that when an inductor current ILb flows through the coil Lb in the direction of an arrow, the direction in which the inductor current ILb flows is the positive direction, and when the inductor current ILb flows in the direction opposite to the direction of the arrow, the direction in which the inductor current ILb flows is the negative direction. Note that the coil Lb corresponds to a “second inductor”.

The power factor correction IC 25 is an integrated circuit to control switching of the NMOS transistors 26a, 26b such that the level of the output voltage Vout reaches a target level (e.g., 400 V) while improving the input power factor of the AC-DC converter 10. Specifically, the power factor correction IC 25 drives the NMOS transistor 26a based on the inductor current ILa flowing through the coil La and the output voltage Vout. Note that the inductor current ILa corresponds to a “first inductor current”.

Further, the power factor correction IC 25 drives the NMOS transistor 26b based on the inductor current ILb flowing through the coil Lb and the ON period of the NMOS transistor 26a. The power factor correction IC 25 has terminals ZCDa, ZCDb, FB, OUTa, OUTb, and the details of the power factor correction IC 25 will be described later. Note that, in an embodiment of the present disclosure, terminals (e.g., a ground terminal) other than the terminal ZCDa and the like of the power factor correction IC 25 are omitted for convenience. Further, the inductor current ILb corresponds to a “second inductor current”.

The NMOS transistors 26a, 26b are power transistors to control power to the load 11 of the AC-DC converter 10. In an embodiment of the present disclosure, it is assumed that the NMOS transistors 26a, 26b are n-type metal oxide semiconductor (NMOS) transistors, but they are not limited thereto, and may be other switching devices such as bipolar transistors or the like, for example. Further, the gate electrode of the NMOS transistor 26a is connected to the terminal OUTa, and the gate electrode of the NMOS transistor 26b is connected to the terminal OUTb. Note that the NMOS transistor 26a corresponds to a “first transistor”, and the NMOS transistor 26b corresponds to a “second transistor”.

The capacitors 27a, 28a are elements to detect that the current value of the inductor current ILa flowing through the substantially coil La reaches zero (hereinafter, “substantially zero” is simply referred to as zero, for convenience) after turning off of the NMOS transistor 26a. Specifically, the capacitors 27a, 28a are connected in series between the source and the drain of the NMOS transistor 26a, and connected in parallel with the NMOS transistor 26a. Note that “substantially zero” corresponds to a “first value”.

For example, upon turning off of the NMOS transistor 26a, a voltage Vswa, which is the drain voltage of the NMOS transistor 26a, rises, and thereafter in response to the flowing of the inductor current ILa being finished, the voltage Vswa drops. Since the capacitors 27a and 28a operate as a voltage divider circuit that divides the voltage Vswa, a voltage Vzcda at the connection point between the capacitors 27a and 28a results in a voltage corresponding to the voltage Vswa. Thus, the power factor correction IC 25 can detect the timing at which the inductor current ILa reaches zero by detecting the voltage Vzcda. Note that the voltage Vzcda is applied to the terminal ZCDa of the power factor correction IC 25. Further, in response to the current value of the inductor current ILa reaching zero, the voltage Vzcda results in reaching a reference voltage Vref1.

Similarly, the capacitors 27b and 28b are elements to detect that the current value of the inductor current ILb flowing through the coil Lb reaches zero after turning off of the NMOS transistor 26b. Specifically, the capacitors 27b, 28b are connected in series between the source and the drain of the NMOS transistor 26b, and connected in parallel with the NMOS transistor 26b. Note that “substantially zero” corresponds to a “second value”.

For example, upon turning off of the NMOS transistor 26b, a voltage Vswb, which is the drain voltage of the NMOS transistor 26b, rises, and thereafter in response to the flowing of the inductor current ILb being finished, the voltage Vswb drops. Since the capacitors 27b, 28b operate as a voltage divider circuit that divides the voltage Vswb, a voltage Vzcdb at the connection point between the capacitors 27b and 28b results in a voltage corresponding to the voltage Vswb. Thus, the power factor correction IC 25 can detect the timing at which the inductor current ILb reaches zero by detecting the voltage Vzcdb. Note that the voltage Vzcdb is applied to the terminal ZCDb of the power factor correction IC 25. Further, in response to the current value of the inductor current ILb reaching zero, the voltage Vzcdb results in reaching the reference voltage Vref1.

The resistors 30, 31 configure a voltage divider circuit to divide the output voltage Vout1, to thereby generate a feedback voltage Vfb that is used when switching the NMOS transistors 26a, 26b. Note that the feedback voltage Vfb generated at the node at which the resistors 30 and 31 are connected is applied to the terminal FB.

### Power Factor Correction IC 25

### Configuration of Power Factor Correction IC 25

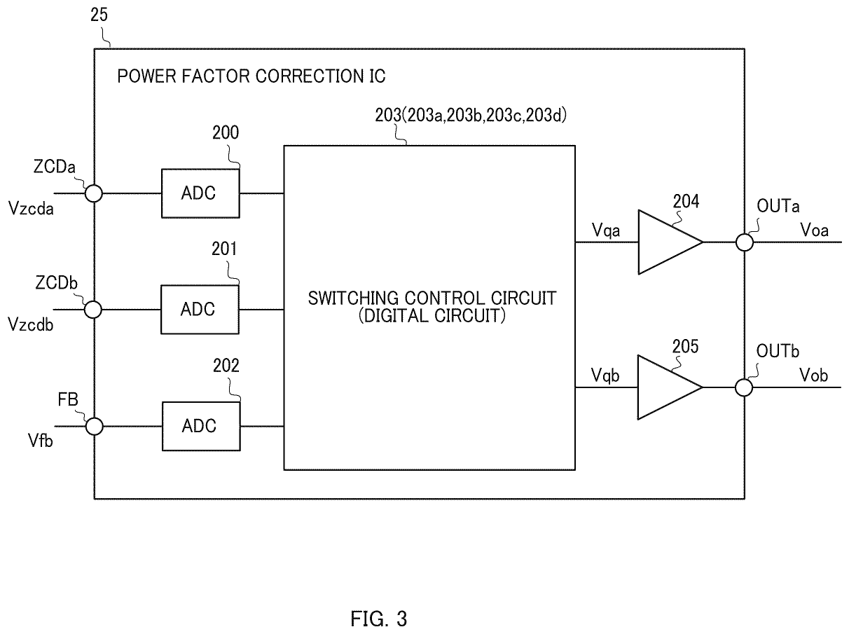

FIG. 3 is a diagram illustrating an example of the power factor correction IC 25. The power factor correction IC 25 includes analog-to-digital converters (ADCs: AD converters) 200 to 202, a switching control circuit 203, and buffer circuits 204, 205. Note that the switching control circuit 203 is configured with a digital circuit.

The AD converter 200 converts the voltage Vzcda into a digital value, the AD converter 201 converts the voltage Vzcdb into a digital value, and the AD converter 202 converts the feedback voltage Vfb into a digital value.

The switching control circuit 203 outputs drive signals Vqa, Vqb to drive the NMOS transistors 26a, 26b, based on the feedback voltage and Vfb the voltages Vzcda, Vzcdb corresponding to the inductor currents Ila, Ilb, respectively. The switching control circuit 203 is a digital circuit configured with a logic circuit of a wired logic type to execute various arithmetic calculations, and includes, for example, a logic gate, a flip-flop, and a memory. However, the switching control circuit 203 may be a digital signal processor (DSP) or a microcomputer. Note that details of the switching control circuit 203 will be described later.

The buffer circuit 204 is a driver circuit to drive the NMOS transistor 26a in response to the drive signal Vqa. Specifically, the buffer circuit 204 turns on the NMOS transistor 26a, in response to the drive signal Vqa reaching a high level (hereinafter, high or high level), and turns off the NMOS transistor 26a, in response to the drive signal Vqa reaching a low level (hereinafter, low or low level).

Similarly, the buffer circuit 205 is a driver circuit to drive the NMOS transistor 26b, in response to the drive signal Vqb. Specifically, the buffer circuit 205 turns on the NMOS transistor 26b, in response to the drive signal Vqb going high, and turns off the NMOS transistor 26b, in response to the drive signal Vqb going low.

### Configuration of Switching Control Circuit 203a

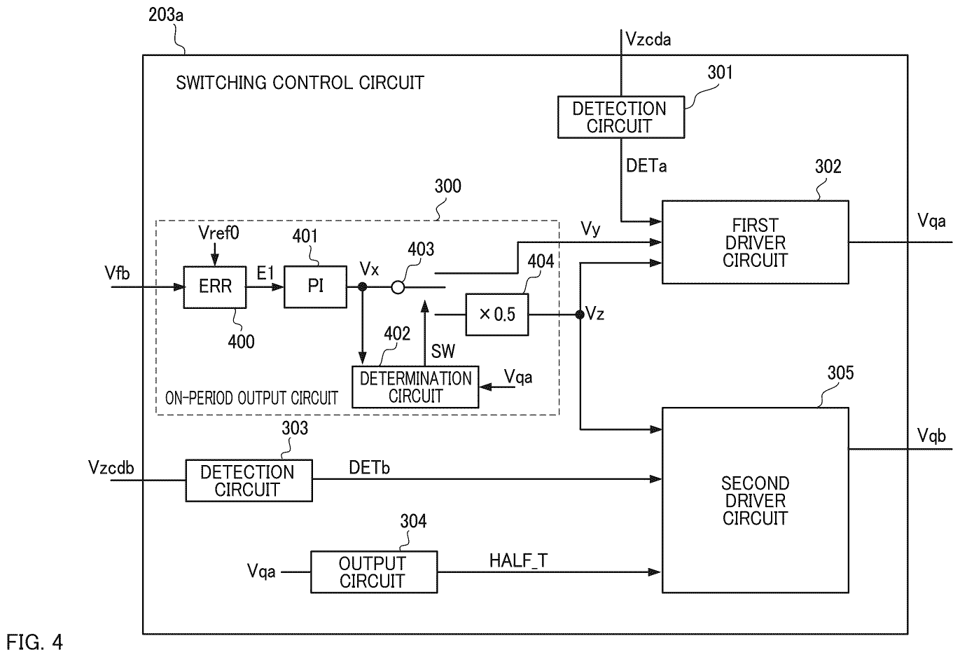

FIG. 4 illustrates an example of a switching control circuit 203a which is an embodiment of the switching control circuit 203. The switching control circuit 203a outputs the drive signals Vqa, Vqb, based on the inductor currents ILa, ILb and the feedback voltage Vfb.

Specifically, when the load 11 is in a light load state, the switching control circuit 203a causes the boost chopper circuit of the first system to operate, to switch the NMOS transistor 26a. Meanwhile, when the load 11 is in a heavy load state, the switching control circuit 203a causes the boost chopper circuits of the first and second systems to operate, to switch the NMOS transistors 26a, 26b.

Note that the load 11 being in the light load state indicates, for example, that the value of the current flowing through the load 11 is smaller than a predetermined value, and the load being in the heavy load 11 state indicates, for example, that the value of the current flowing steadily through the load 11 is larger than the predetermined value.

In an embodiment of the present disclosure, in response to the load 11 entering the heavy load state, and to the ON period during which the NMOS transistor 26a is on exceeding a predetermined time period Ta, the boost chopper circuits of the two systems are operated, which will be described later in detail. Meanwhile, when the boost chopper circuits of the two systems are operating, only the boost chopper circuit of the first system is operated, in response to the load 11 entering the light load state, and to the ON period during which the NMOS transistors 26a, 26b are on decreasing shorter than a predetermined time period Tb.

The switching control circuit 203a includes an ON-period output circuit 300, a detection circuit 301, 303, a first driver circuit 302, an output circuit 304, and a second driver circuit 305.

The ON-period output circuit 300 outputs the ON periods Vy, Vz of the NMOS transistors 26a, 26b, based on the feedback voltage Vfb. The ON-period output circuit 300 includes an error amplifier circuit (ERR) 400, a PI control circuit (PI) 401, a determination circuit 402, a switch 403, and a multiplier circuit 404. Note that the “ON period” is a digital value indicating a voltage, for example.

The error amplifier circuit 400 calculates an error El, which is the difference between a reference voltage Vref0 and the feedback voltage Vfb, the reference voltage Vref0 being the reference for the output voltage Vout at the target level (e.g., 400 V). Note that the feedback voltage Vfb is a digital value obtained by converting the feedback voltage Vfb by the AD converter 202.

The PI control circuit 401 calculates the integral value of the error E1, to output an ON period Vx to cause the level of the feedback voltage Vfb to be equal to the level of the reference voltage Vref0, based on the integral value.

The determination circuit 402 determines whether the ON period Vx is equal to or longer than the predetermined time period Ta. Then, according to the determination, the determination circuit 402 determines which one of the ON period Vy or Vz will be outputted by the ON-period output circuit 300. Specifically, when the ON period Vx is shorter than the predetermined time period Ta, the determination circuit 402 controls the switch 403 so as to cause the ON-period output circuit 300 to output the ON period Vx as the ON period Vy. In other words, the determination circuit 402 controls the switch 403 so as to connect the PI control circuit 401 and the first driver circuit 302. In this case, the AC-DC the converter 10 operates using only the boost chopper circuit of the first system.

Meanwhile, when the ON period Vx is, for example, equal to or longer than the predetermined time period Ta, the determination circuit 402 controls the switch 403 so as to connect the PI control circuit 401 and the multiplier circuit 404. The multiplier circuit 404 according to an embodiment of the present disclosure multiplies the inputted ON period Vx by 0.5, to output the ON period Vz, which is a half of the ON period Vx. Note that when the PI control circuit 401 and the first driver circuit 302 are connected, the multiplier circuit 404 outputs the ON period Vz of “0”.

Accordingly, when the ON period Vx is shorter than the predetermined time period Ta, the first driver circuit 302 turns on the NMOS transistor 26a in the ON period Vy (=Vx), and thus only the boost chopper circuit of the first system operates. Meanwhile, when the ON period Vx is longer than the predetermined time period Ta, the first driver circuit 302 and the second driver circuit 305 turn on the NMOS transistors 26a, 26b in the ON period Vz (=Vx/2). Thus, AC-DC converter 10 operates using the boost chopper circuits of the first and second systems.

The detection circuit 301 detects whether the inductor current ILa decreases to substantially zero. Specifically, the detection circuit 301 outputs a high signal DETa indicating that the inductor current ILa decreases to substantially zero, in response to the voltage value of the voltage Vzcda that corresponds to the inductor current ILa reaching the reference voltage Vref1.

### First Driver Circuit 302

The first driver circuit 302 drives the NMOS transistor 26a, in response to the drive signal Vqa according to the inputted ON periods Vy, Vz. Specifically, the first driver circuit 302 outputs the drive signal Vqa to turn on the NMOS transistor 26a, in response to the inductor current ILa decreasing to substantially zero and the detection circuit 301 outputting the high signal DETa.

Thereafter, when the ON period Vx is shorter than the predetermined time period Ta, the first driver circuit 302 outputs the drive signal Vqa to turn off the NMOS transistor 26a, in response to the ON period Vy having elapsed.

Meanwhile, when the ON period Vx is equal to or longer than the predetermined time period Ta, the first driver circuit 302 outputs the drive signal Vqa to turn off the NMOS transistor 26a, in response to the ON period Vz having elapsed since turning on of the NMOS transistor 26a. The ON period Vy or Vz used in the first driver circuit 302 corresponds to a “first time period”.

The detection circuit 303 detects whether the inductor current ILb decreases to substantially zero and the voltage value of the voltage Vzcdb corresponding to the inductor current ILb reaches the reference voltage Vref1. Specifically, the detection circuit 303 outputs a high signal DETb, in response to the voltage value of the voltage Vzcdb that corresponds to the inductor current ILb reaching the reference voltage Vref1.

### Output Circuit 304

The output circuit 304 outputs the timing corresponding to a half period Th of the switching period of the NMOS transistor 26a. Specifically, the output circuit 304 starts measuring the switching period of the NMOS transistor 26a, in response to the first driver circuit 302 outputting the high drive signal Vqa. Then, in response to the first driver circuit 302 outputting the high drive signal Vqa again, the output circuit 304 calculates the half period Th of the switching period of the NMOS transistor 26a, and outputs a high signal HALF_T during a predetermined time period Thalf that includes the timing corresponding to the half period Th. Note that the predetermined time period Thalf is a time period that has been previously determined, and corresponds to a “predetermined time period”.

### Second Driver Circuit 305

The second driver circuit 305 drives the NMOS transistor 26b in response to the drive signal Vqb corresponding to the inputted ON period Vz. Specifically, the second driver circuit 305 outputs the drive signal Vqb to turn off the NMOS transistor 26b, when the ON period Vx is shorter than the predetermined time period Ta.

Meanwhile, in the case where the ON period Vx is equal to or longer than the predetermined period Ta, the second driver circuit 305 outputs the drive signal Vqb to turn on the NMOS transistor 26b, in response to the inductor current ILb decreasing to substantially zero, and to the detection circuit 303 outputting the high signal DETb, while the output circuit 304 is outputting the high signal HALF_T.

Thereafter, the second driver circuit 305 outputs the drive signal Vqb to turn off the NMOS transistor 26b, in response to the ON period Vz having elapsed. Further, the ON period Vz used in the second driver circuit 305 corresponds to a “second time period”.

### Operation by Only Boost Chopper Circuit of First System

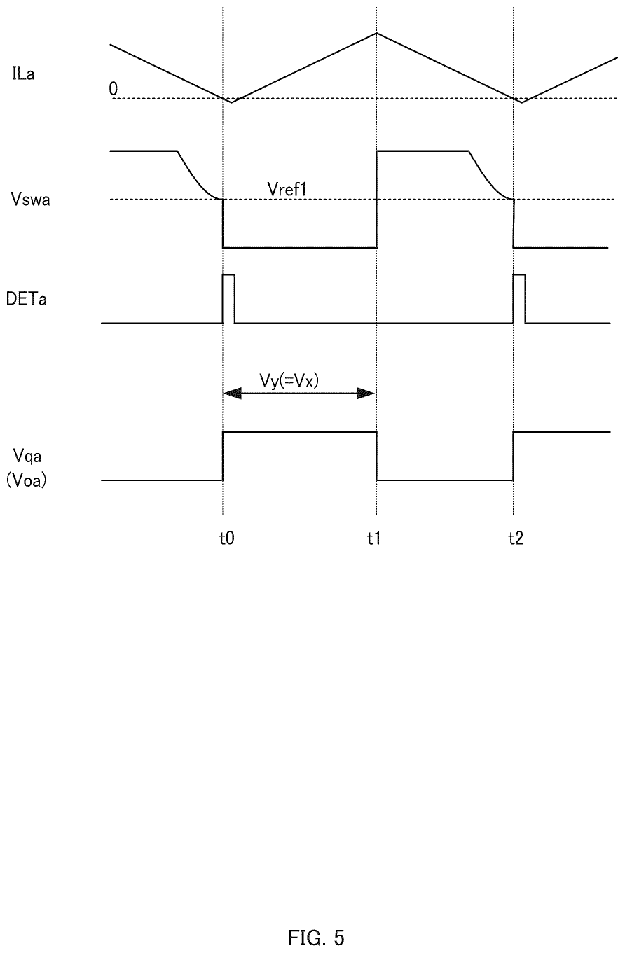

FIG. 5 is a diagram illustrating an example of an operation of the switching control circuit 203a when only the boost chopper circuit of the first system operates. In this case, the ON-period output circuit 300 outputs the ON period Vy that is the ON period Vx corresponding to the feedback voltage Vfb, and the second driver circuit 305 outputs the drive signal Vqb to turn off the NMOS transistor 26b.

Accordingly, the following describes the operation when the AC-DC converter 10 generates the output voltage Vout at the target level from the predetermined AC voltage Vac, and supplies power to a constant load. At the same time, the following also describes the operation of the first driver circuit 302 outputting the drive signal Vqa to drive the NMOS transistor 26a, based on the ON period Vy.

First, in response to the inductor current ILa decreasing to zero at time to, the detection circuit 301 changes the signal DETa to high. Then, in response to the signal DETa going high, the first driver circuit 302 outputs the high signal Vqa.

In response to the drive signal Vga going high, the NMOS transistor 26a is turned on, and thus the inductor current ILa increases.

Further, in response to the drive signal Vqa going high and the on period Vy having elapsed, the first driver circuit 302 turns off the NMOS transistor 26a and outputs the low drive signal Vqa as illustrated at time t1. As a result, the inductor current ILa gradually decreases. Further, in response to the inductor current ILa decreasing to zero at time t2, the operation at time to is repeated.

Here, when the AC-DC converter 10 is generating the output voltage Vout at the target level from the predetermined AC voltage Vac, the capacitance of the capacitor 23 is sufficiently large and the feedback voltage Vfb is substantially constant in the time period of about one period of Vac. As a result, the ON period Vy outputted from the ON-period output circuit 300 also becomes substantially constant, and thus the time period during which the NMOS the transistor 26a is on (e.g., the time period from time t0 to t1) results in being substantially constant as well.

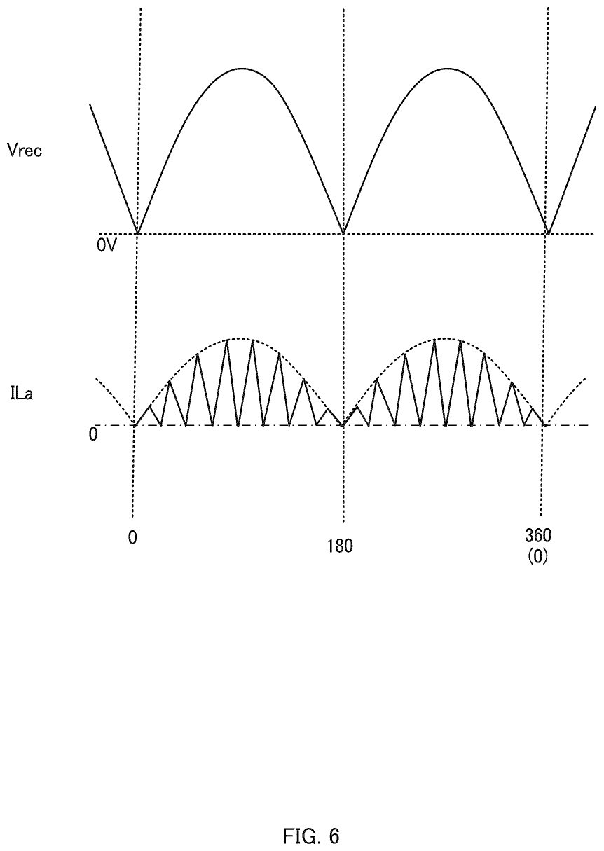

Further, when the NMOS the transistor 26a is turned on, the current value of the inductor current ILa increases with a rise in the level of the voltage Vrec obtained by rectifying the AC voltage Vac. As a result, the waveform of the peak values of the inductor current ILa results in being similar to the waveform of the voltage Vrec, as illustrated in FIG. 6.

As the level of the peak value of the inductor current ILa when the NMOS transistor 26a is turned off rises, the time period for the inductor current ILa to reach zero when NMOS the transistor 26a is off increases. Accordingly, when the level of the voltage Vrec is low, the switching frequency of the NMOS transistor 26a rises, and when the level of voltage Vrec is high, the switching frequency of the NMOS transistor 26a lowers.

### Operations by Boost Chopper Circuits of First and Second Systems

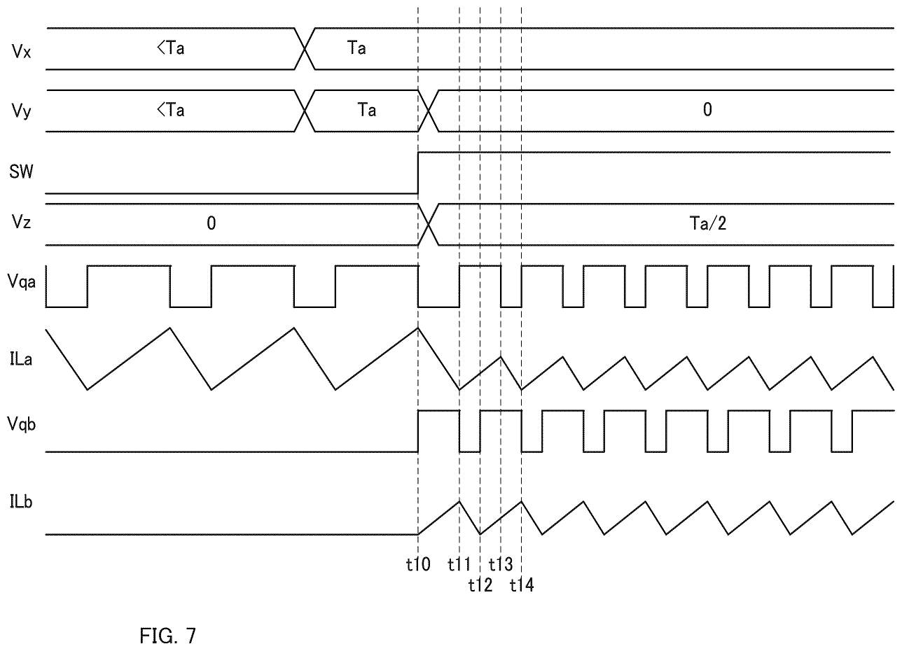

FIG. 7 is a diagram illustrating an operation example of the switching control circuit 203a. In FIG. 7, a description will be given of the operation of the switching control circuit 203a when transitioning from the state in which only the boost chopper circuit of the first system operates to the state in which the boost chopper circuits of the first and second systems operate.

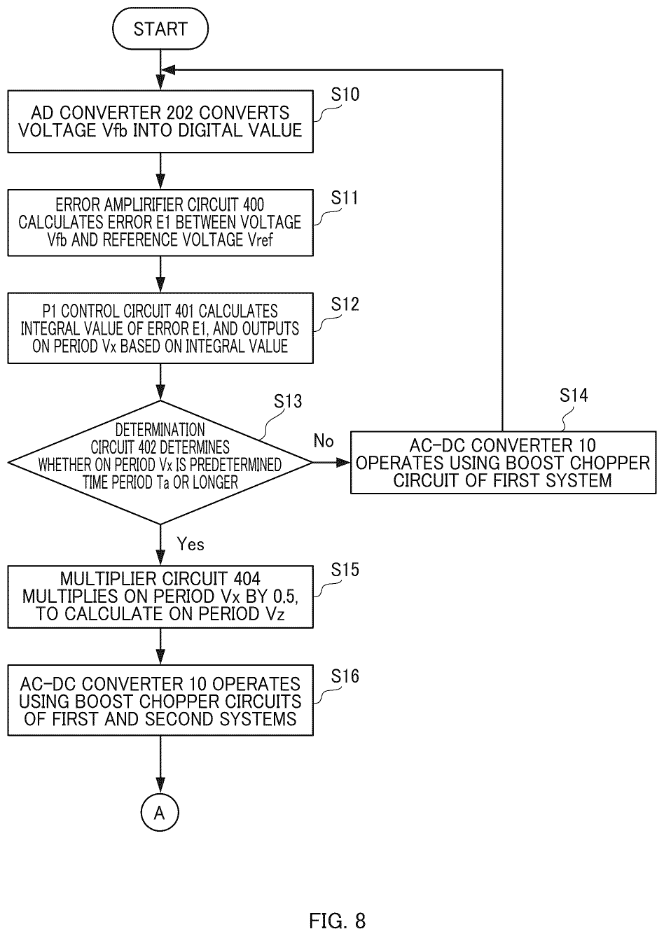

It is assumed that before time t10, the feedback voltage Vfb is the voltage causing the PI control circuit 401 to output the ON period Vx of the predetermined time period Ta after outputting the ON period Vx shorter than the predetermined time period Ta. Further, it is assumed that the ON-period output circuit 300 is outputting the ON period Vy, which changes from the time period that is shorter than the predetermined time period Ta to the predetermined time period Ta. Accordingly, the ON-period output circuit 300 causes the second driver circuit 305 to stop switching while turning off, the NMOS transistor 26b. Further, before time t10, the switching control circuit 203a performs the operation described with reference to FIG. 5, in which the operation is performed by only the boost chopper circuit of the first system. Further, it is assumed that the operations of steps S10 to S12 in FIG. 8 are constantly performed, and before time t10, the determination circuit 402 determines that the ON period Vx is shorter than the predetermined time period Ta (NO in step S13 in FIG. 8).

At time t10, the determination circuit 402 outputs a high signal SW, because when the drive signal Vqa changes to low, the ON period Vx is equal to or longer than the predetermined period Ta (YES in step S13 of FIG. 8). Accordingly, the determination circuit 402 causes the switch 403 to connect the PI control circuit 401 and the multiplier circuit 404.

Then, in response to the multiplier circuit 404 calculating the ON period Vz obtained by multiplying the ON period Vx by 0.5 (i.e., Ta/2) (step S15 in FIG. 8), the second driver circuit 305 outputs the drive signal Vqb to turn on the NMOS transistor 26b, because the inductor current ILb is zero. Upon turning on of the NMOS transistor 26b, the inductor current ILb starts to increase. In other words, the AC-DC the converter 10 operates using the boost chopper circuits of the first and second systems (step S16 in FIG. 8).

At time t11, at which the ON period of the NMOS transistor 26b is the ON period Vz of Ta/2, the second driver circuit 305 outputs the drive signal Vqb to turn off the NMOS transistor 26b. Thereafter, the inductor current ILb starts to decrease. Further, at time t11, in response to the inductor current ILa reaching zero, the first driver circuit 302 outputs the drive signal Vqa to turn on the NMOS transistor 26a.

At time t12, at which the inductor current ILb decreases to zero, the second driver circuit 305 outputs the drive signal Vqb to turn on the NMOS transistor 26b. Hereinafter, the second driver circuit 305 repeats the same operation.

At time t13, at which the ON period of the NMOS transistor 26a is the ON period Vz of “50”, the first driver circuit 302 outputs the drive signal Vqa to turn off the NMOS transistor 26a. Thereafter, the inductor current ILa starts to decrease.

At time t14, at which the inductor current ILa reaches zero, the first driver circuit 302 outputs the drive signal Vqa to turn on the NMOS transistor 26a. Hereinafter, the first driver circuit 302 repeats the same operation.

As such, when the ON period Vx is shorter than the predetermined period Ta, the switching control circuit 203a drives only the NMOS transistor 26a with the ON period Vy that is the ON period Vx based on the feedback voltage Vfb. Meanwhile, in response to the ON period Vx becoming equal or longer than the predetermined period Ta, the switching control circuit 203a drives the NMOS transistors 26a, 26b with the ON period Vz that is a half of the ON period Vx.

The operation when the AC-DC converter 10 transitions to an interleaved operation has been described above. If the frequencies of the drive signals Vqa, Vqb differ even slightly, it would not be possible to turn on the NMOS transistors 26a, 26b in the predetermined phase relationship so that the two boost chopper circuits would perform the interleaved operation (i.e., the relationship in which the phase difference between the timings at which the NMOS transistors 26a, 26b are turned on is 180°).

In particular, when the switching frequencies of the drive signals Vqa, Vqb are slightly different, a low frequency component, so-called beat frequency, is generated due to the difference between those frequencies, which may cause occurrence of resonance at the input line filter 20. Further, if the input line filter 20 enters a resonant state, the full-wave rectified voltage Vrec will fluctuate, which may cause the frequencies of the drive signals Vqa, Vqb to slightly differ.

### Configuration of Switching Control Circuit 203a

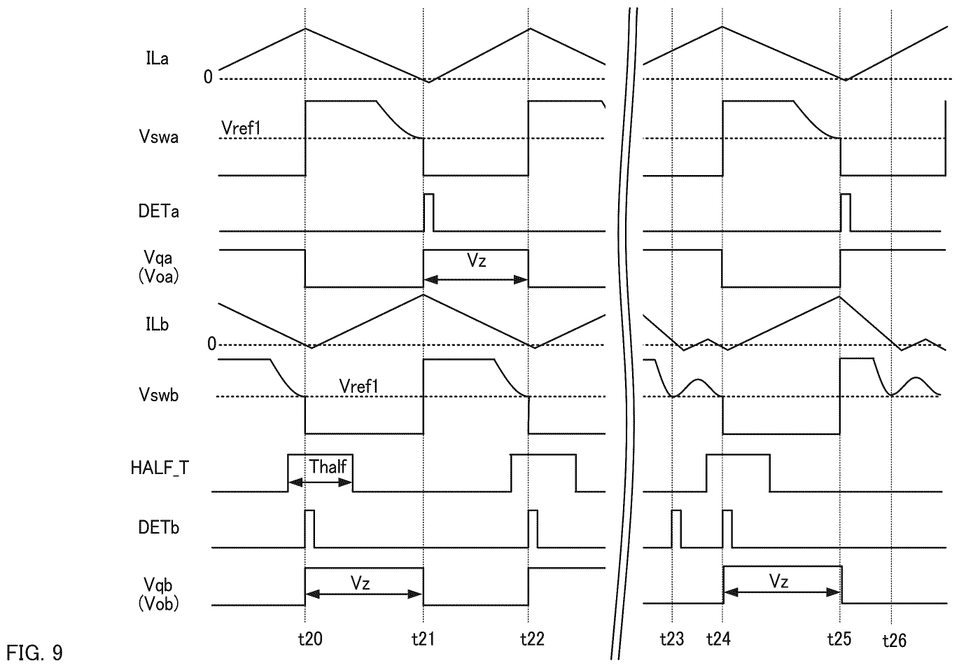

FIG. 9 is a diagram illustrating an operation example of the switching control circuit 203a. Note that the time period from time t20 to t22 indicates the operation when the initial timing at which the inductor current ILb reaches zero coincides with the timing corresponding to the half period Th. Meanwhile, the time period from time t23 indicates the operation when the initial timing at which the inductor current ILb reaches zero shifts from the timing corresponding to the half period Th. In this case, the rectified voltage Vrec is lowered. Further, it is assumed that the NMOS transistors 26a, 26b are operating with the ON period Vz with which the NMOS transistors 26a, 26b are on in a half of the switching period.

Before time t20, the NMOS transistor 26a is turned on, and at time t20 at which the ON period Vz has elapsed, the NMOS transistor 26a is turned off. Thus, the voltage Vzcda exceeds the reference voltage Vref1, and the inductor current ILa starts to decrease.

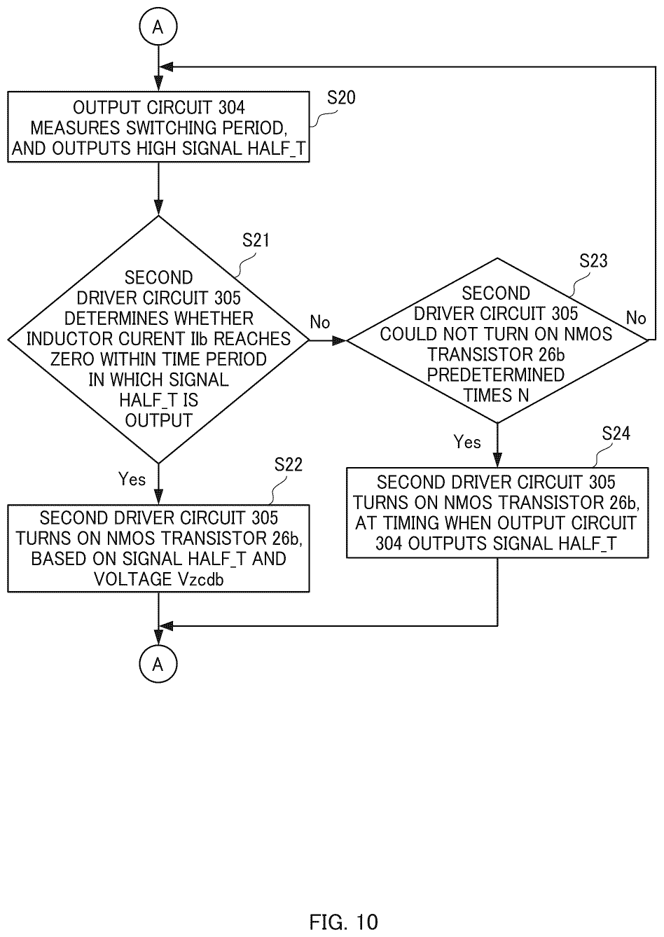

Meanwhile, the NMOS transistor 26b has been turned off before time t20, and the inductor current ILb decreases to zero. Thus, the detection circuit 303 outputs the high signal DETb. Time t20 is the timing corresponding to the half-period Th, and the output circuit 304 is outputting the high signal HALF_T (step S20 in FIG. 10). The inductor current ILb reaches zero (YES in step S21 in FIG. 10), and thus the second driver circuit 305 outputs the drive signal Vqb to turn on the NMOS transistor 26b (step S22 in FIG. 10). Then, the voltage Vzcdb drops below the reference voltage Vref1, and the inductor current ILb starts to increase. Note that the time period during which the output circuit 304 outputs the high signal HALF_T, illustrated in FIG. 9 and subsequent figures, is just an example, and the output circuit 304 may start outputting it such that the timing at which the half period Th has elapsed is positioned at the center of the time period, or a time period before the half period Th has elapsed may be longer than a time period after the half period Th has elapsed.

At time t21, at which the ON period Vz has elapsed since time t20, the NMOS transistor 26b is turned off and the inductor current ILb starts to decrease. Then, the decreased inductor current ILa reaches zero, and the detection circuit 301 outputs the high signal DETa, and thus the first driver circuit 302 outputs the drive signal Vqa to turn on the NMOS transistor 26a. The same operation is repeated from time t22.

As such, in response to the inductor current ILb reaching zero during the time period during which the output circuit 304 is outputting the high signal HALF_T, the second driver circuit 305 outputs the drive signal Vqb to turn on the NMOS transistor 26b. Thus, the phase difference between the timings at which the NMOS transistors 26a, 26b are turned on is likely to be constant.

Further, the case in which the rectified voltage Vrec fluctuates low has been described here, however, when the rectified voltage Vrec fluctuates high, the timing at which the inductor current ILb reaches zero may be delayed with respect to the time period during which the signal HALF_T is high, and may fall within the time period during which the signal HALF_T is low.

In this case, when the number of times n the NMOS transistor 26b has not been able to be turned on is less than the predetermined number of times N (NO in step S23 of FIG. 10), the second driver circuit 305 waits until the output circuit 304 outputs the high signal HALF_T (step S20 in FIG. 10). Meanwhile, when the number of times n the NMOS transistor 26b has not been able to be turned on reaches the predetermined number of times N (YES in step S23 in FIG. 10), the second driver circuit 305 turns on the NMOS transistor 26b at the next timing at which the output circuit 304 outputs the signal HALF_T (step S24 in FIG. 10).

In the above, the case has been described in which the timing at which the inductor current ILb reaches zero for the first time falls within the time period during which the output circuit 304 is outputting the high signal HALF_T. The following describes the case in which the timing at which the inductor current ILb reaches zero for the second or subsequent times falls within the time period during which the output circuit 304 is outputting the high signal HALF_T.

Before time t23, the NMOS transistor 26b is turned off, and the detection circuit 303 outputs the high signal DETb at time t23, at which the inductor current ILb reaches zero for the first time. However, time t23 is not the timing corresponding to the half-period Th, but the output circuit 304 is outputting the low signal HALF_T, and thus the second driver circuit 305 does not output the drive signal Vqb to turn on the NMOS transistor 26b (steps S23, S24 in FIG. 10).

At time t24, at which the inductor current ILb reaches zero for the second time, the detection circuit 303 outputs the high signal DETb. Further, time t24 is the timing corresponding to the half period Th, and since the output circuit 304 is outputting the high signal HALF_T, and thus the second driver circuit 305 outputs the drive signal Vqb to turn on the NMOS transistor 26b (steps S21, S22 in FIG. 10).

At time t25, at which the ON period Vz has elapsed since time t24, the second driver circuit 305 outputs the drive signal Vqb to turn off the NMOS transistor 26b. Thereafter, the inductor current ILb starts to decrease. The same operation is repeated from time t26.

As such, even if the inductor current ILb reaches zero during the time period during which the output circuit 304 is outputting the low signal HALF_T, the second driver circuit 305 does not output the drive signal Vqb to turn on the NMOS transistor 26b. Thereafter, in response to the inductor current ILb reaching zero during the time period during which the output circuit 304 is outputting the high signal HALF_T, the second driver circuit 305 outputs the drive signal Vqb to turn on the NMOS transistor 26b. Thus, the phase difference between the timings at which the NMOS transistors 26a, 26b are turned on is likely to be constant. This makes it possible to provide a switching control circuit that suppresses shift in phase difference even when the rectified voltage fluctuates during the interleaved operation.

### Modifications =

### Configuration of Switching Control Circuit 203b

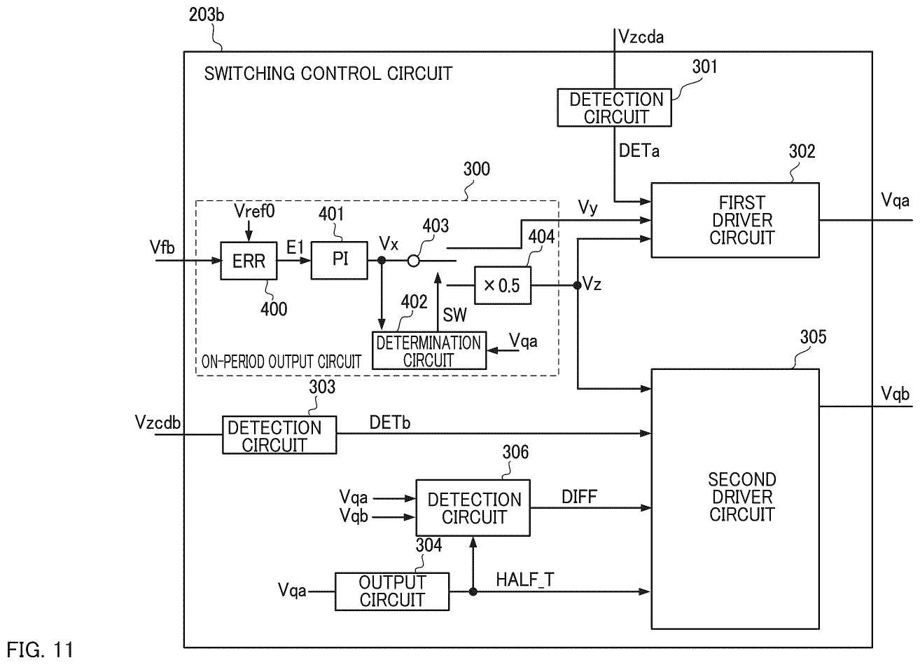

FIG. 11 is an example of a switching control circuit 203b, which is an embodiment of the switching control circuit 203. In response to the difference between the half period Th and the phase difference in the switching timing between the drive signals Vqa, Vqb reaching a predetermined value or more, the switching control circuit 203b turns on the NMOS transistor 26b in the half period Th.

The switching control circuit 203b includes the ON-period output circuit 300, the detection circuits 301, 303, a detection circuit 306, the first driver circuit 302, the output circuit 304, and the second driver circuit 305.

The detection circuit 306 detects the difference between the phase difference in the switching between the half period Th and the NMOS transistors 26a, 26b. Specifically, the detection circuit 306 counts the phase difference from when the NMOS transistor 26a is switched to when the NMOS transistor 26b is switched, based on the drive signals Vga, Vqb, to detect whether the difference ΔT between the phase difference and the half period Th exceeds a predetermined value T0. Then, the detection circuit 306 counts, upon detecting that the difference ΔT between the phase difference and the half period Th exceeds the predetermined value T0, and upon determining that the number of times n1, which is a count value, exceeds the predetermined number of times N1, the detection circuit 306 outputs, to the second driver circuit 305, a signal DIFF to turn on the NMOS transistor 26b at the timing at which the half period Th has elapsed since turning on of the NMOS transistor 26a. Thereafter, the detection circuit 306 resets the number of times n1. Note that the detection circuit 306 corresponds to a “detection circuit”, and the signal DIFF corresponds to a “detection result”.

Further, the second driver circuit 305 turns on the NMOS transistor 26b, in response to the half period Th having elapsed since turning on of the NMOS transistor 26a, based on the signal DIFF that is outputted when the difference ΔT exceeds the predetermined value T0. In this modification, it is assumed that the phase difference is the difference in the timing at which the NMOS transistors 26a, 26b are switched, but it may also be assumed that the phase difference is the difference in the timing at which the NMOS transistor 26a, 26b are turned on. In this case, the phase difference can be detected more accurately.

Note that the timing at which the NMOS transistor 26a is switched corresponds to a “first timing”, and the timing at which the NMOS transistor 26b is switched corresponds to a “second timing”. Further, the phase difference corresponds to a “first difference”, and the difference ΔT corresponds to a “second difference”. Further, the predetermined value T0 corresponds to a “first predetermined value”.

### Operation of Switching Control Circuit 203b When Difference ΔT is Less Than Predetermined Value T0

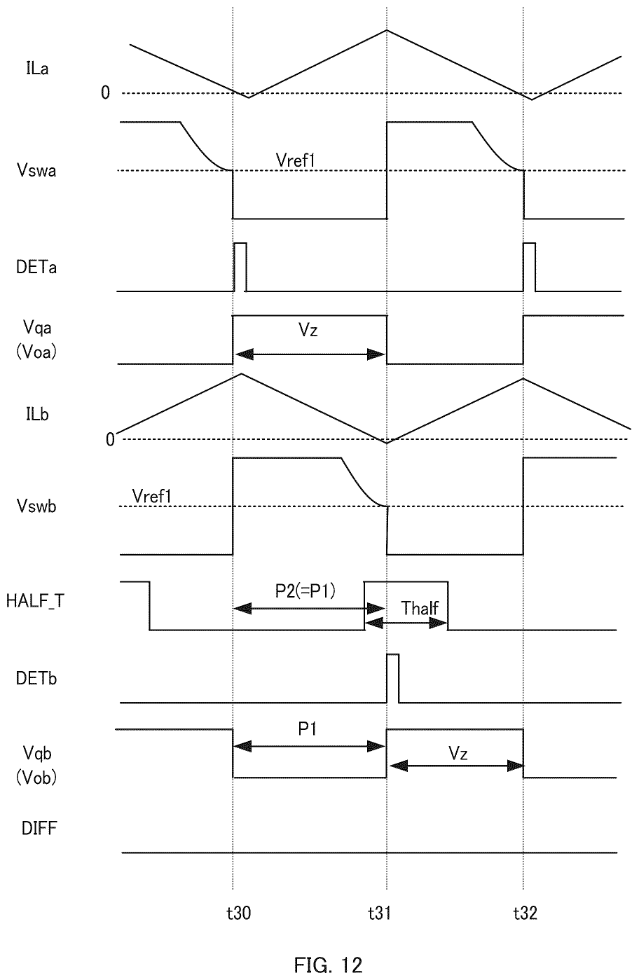

FIG. 12 is a diagram illustrating an operation example of the switching control circuit 203b. Note that the time period from time t30 to t32 indicates the operation when the NMOS transistor 26b is turned on at the timing at which the half period Th has elapsed since turning on of the NMOS transistor 26a. Further, it is assumed that the NMOS transistors 26a, 26b are operating in the ON period Vz in which the NMOS transistors 26a, 26b are on in a half of the switching period.

At time t30, the inductor current ILa decreases to zero, and the detection circuit 301 outputs the high signal DETa, and thus the first driver circuit 302 turns on the NMOS transistor 26a. Thus, the voltage Vzcda drops below the reference voltage Vref1, and the inductor current ILa starts to increase. Meanwhile, the NMOS transistor 26b is turned on before time t30, the inductor current ILb increases, and the ON period Vz has elapsed, and thus the second driver circuit 305 turns off the NMOS transistor 26b.

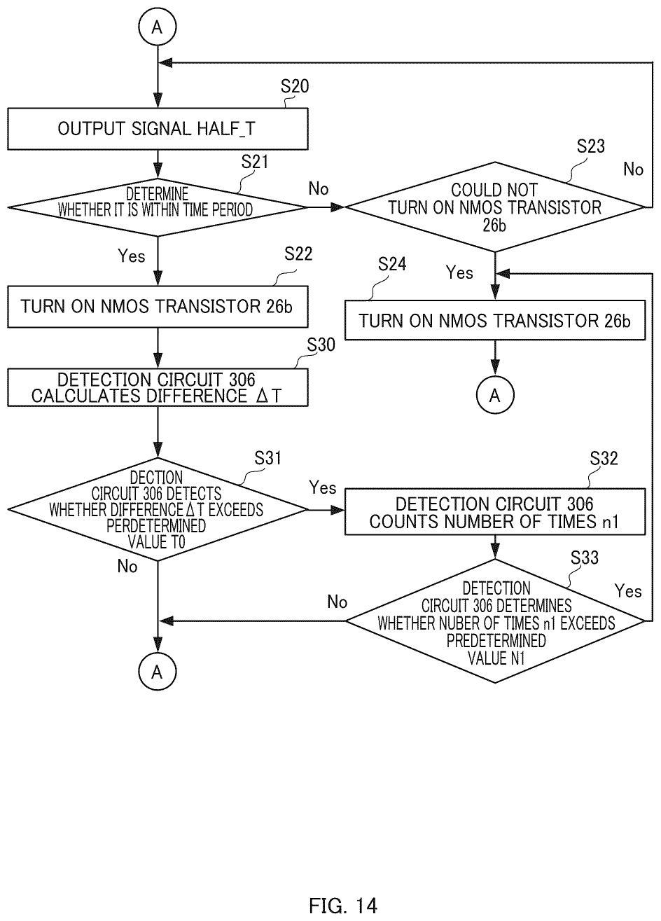

At time t31, the ON period Vz has elapsed since turning on of the NMOS transistor 26a, and the first driver circuit 302 turns off the NMOS transistor 26a. Meanwhile, when the inductor current ILb decreases and the output circuit 304 is outputting the high signal HALF_T, the detection circuit 303 outputs the high signal DETb, and thus the second driver circuit 305 turns on the NMOS transistor 26b (steps S20, S21, S22 in FIG. 14). Thus, the voltage Vzcdb drops below the reference voltage Vref1, and the inductor current ILb starts to increase.

Here, the time period from when the NMOS transistor 26a is turned on to when the NMOS transistor 26b is turned on is defined as a time period P1, and the half period Th is defined as a time period P2. When the operation is performed as described in FIG. 12, the time periods P1 and P2 are equal, and the detection circuit 306 calculates the difference ΔT that is “0” (step S30 in FIG. 14). Then, since the difference ΔT is smaller than the predetermined value T0, the detection circuit 306 does not output the high signal DIFF (NO in step S31 in FIG. 14).

The second driver circuit 305 does not turn on the NMOS transistor 26b in the half period Th. The same operation is repeated from time t32.

### Operation of Switching Control Circuit 203b When Difference ΔT is Predetermined Value T0 or More

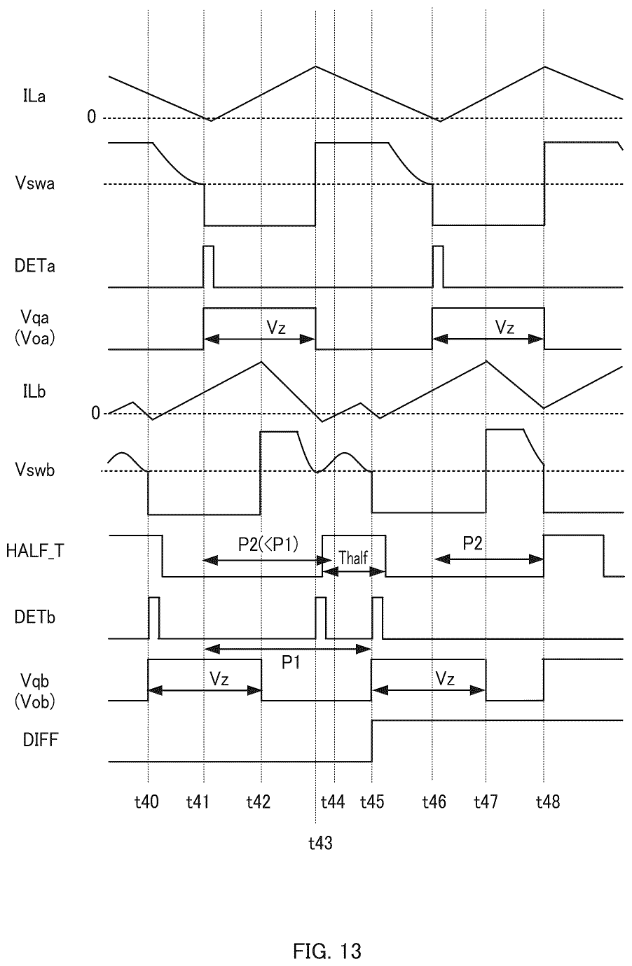

FIG. 13 is a diagram illustrating an operation example of the switching control circuit 203b. Note that illustrated is an operation of the case in which the initial timing at which the inductor current ILb reaches zero shifts from the half period Th. In the case of FIG. 13, it is assumed that the rectified voltage Vrec is decreasing due to fluctuations.

At time t40, the output circuit 304 outputs the high signal HALF_T, the inductor current ILb reaches zero, and the detection circuit 303 outputs the high signal DETb, and thus the second driver circuit 305 turns on the NMOS transistor 26b (steps S20, S21, S22 in FIG. 14). Thus, the voltage Vzcdb drops below the reference voltage Vref1, and the inductor current ILb starts to increase.

In response to the inductor current ILa reaching zero and the detection circuit 301 outputting the high signal DETa at time t41, the first driver circuit 302 turns on the NMOS transistor 26a.

At time t42, at which the ON period Vz has elapsed since time t40, the second driver circuit 305 turns off the NMOS transistor 26b. Thus, the voltage Vzcdb exceeds the reference voltage Vref1, and the inductor current ILb starts to decrease.

At time t43, at which the ON period Vz has elapsed since time t41, the first driver circuit 302 turns off the NMOS transistor 26a. Thus, the voltage Vzcda exceeds the reference voltage Vref1, and the inductor current ILa starts to decrease. Then, the inductor current ILb reaches zero for the first time after turning on of the NMOS transistor 26b. Thus, the detection circuit 303 outputs the high signal DETb, but the output circuit 304 outputs the low signal HALF_T, and thus the second driver circuit 305 does not turn on the NMOS transistor 26b (NO in step S23 in FIG. 14).

At time t44, the output circuit 304 outputs the high signal HALF_T (step S20 in FIG. 14).

At time t45, at which the inductor current ILb reaches zero for the second time, the output circuit 304 outputs the high signal HALF_T and the detection circuit 303 outputs the high signal DETb, and thus the second driver circuit 305 turns on the NMOS transistor 26b (steps S21, S22 in FIG. 14).

In this case, the time period P2 is shorter than the time period P1, and thus the detection circuit 306 calculates the difference ΔT (step S30 in FIG. 14) and detects that the difference ΔT exceeds the predetermined value T0 (YES in step S31 in FIG. 14). Then, the detection circuit 306 counts the number of times n1 the difference ΔT exceeds the predetermined value T0 (step S32 in FIG. 14), and in response to the number of times n1 exceeding a predetermined value N1 (“0” in the case of the operation in FIG. 13) (step S33 in FIG. 14), the detection circuit 306 outputs the high signal DIFF. The predetermined value N1 corresponds to a “second predetermined value”.

At time t46, in response to the inductor current ILa reaching zero and the detection circuit 301 outputting the high signal DETa, the first driver circuit 302 turns on the NMOS transistor 26a.

At time t47, at which the ON period Vz has elapsed since time t45, the second driver circuit 305 turns off the NMOS transistor 26b. Thus, the voltage Vzcdb exceeds the reference voltage Vref1, and the inductor current ILb starts to decrease.

At time t48, in response to the output circuit 304 outputting the high signal HALF_T, the second driver circuit 305 turns on the NMOS transistor 26b.

As such, when the time periods P1 and P2 are not equal, the detection circuit 306 outputs the high signal DIFF because the difference ΔT between the half period Th and the phase difference in the switching between the NMOS transistors 26a, 26b exceeds the predetermined value T0. Then, the second driver circuit 305 turns on the NMOS transistor 26b at the half period Th.

When the operation is performed as such, in response to the difference ΔT exceeding the predetermined value T0, the NMOS transistor 26b is turned on at the half period Th, and thus the phase difference in the timing at which the NMOS transistors 26a, 26b are turned on is likely to be constant.

### Configuration of Switching Control Circuit 203c

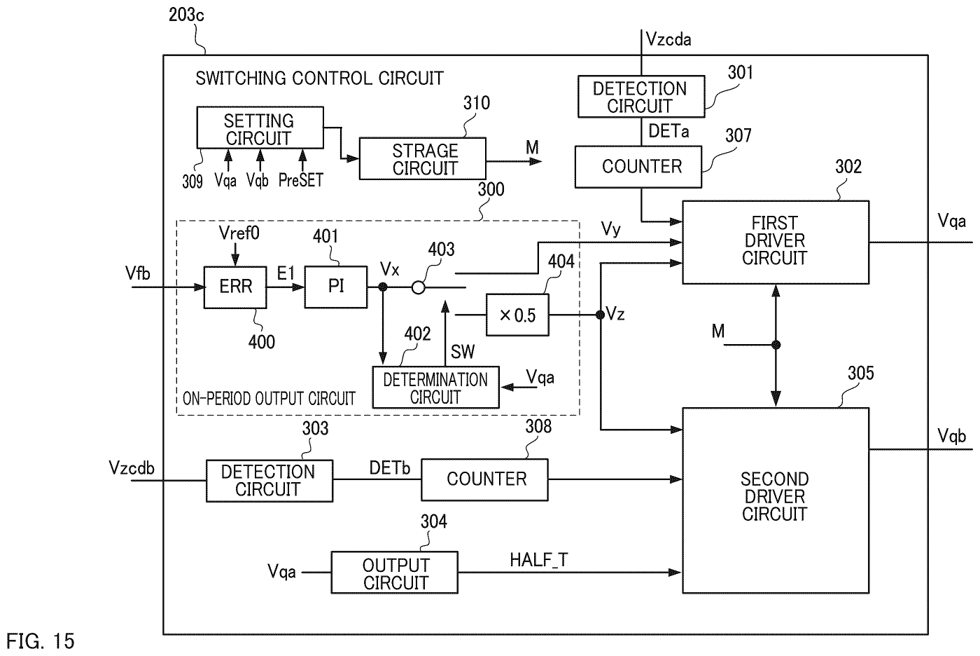

FIG. 15 is an example of a switching control circuit 203c, which is an embodiment of the switching control circuit 203. The switching control circuit 203c turns on each of the NMOS transistors 26a, 26b, in response to the number of times the inductor current Ila, ILb reaches zero reaching a set value M.

The switching control circuit 203c includes the ON-period output circuit 300, the detection circuits 301, 303, the first driver circuit 302, the output circuit 304, the second driver circuit 305, counters 307, 308, a setting circuit 309, and a storage circuit 310.

The counter 307 counts the number of times the inductor current ILa reaches zero. Specifically, the counter 307 counts the number of times the detection circuit 301 outputs the high signal DETa. Note that in response to the count value of the counter 307 reaching the set value M, the first driver circuit 302 turns on the NMOS transistor 26a. Note that the counter 307 corresponds to a “first counter”.

The counter 308 counts the number of times the inductor current ILb reaches zero. Specifically, the counter 308 counts the number of times the detection circuit 303 outputs the high signal DETb. In response to the count value of the counter 308 reaching the set value M, the second driver circuit 305 turns on the NMOS transistor 26b. Note that the counter 308 corresponds to a “second counter”.

The setting circuit 309 sets the set value M, based on the predetermined set value and the predetermined switching frequency of the NMOS transistor 26a, 26b. Specifically, the setting circuit 309 previously sets, a predetermined set value PreSET in the storage circuit 310 as the set value M, the predetermined set value PreSET being a set value to set how many times the inductor current ILa, ILb should reach zero before turning on of the NMOS transistor 26a, 26b. Then, the storage circuit 310 updates the set value M, based on the predetermined switching frequency, which is the previously determined highest frequency of the NMOS transistor 26a, 26b.

More specifically, the setting circuit 309 detects the switching period of the NMOS transistor 26a, 26b based on the drive signal Vqa, Vqb. Then, the setting circuit 309 causes the storage circuit 310 to update the set value M, based on the predetermined set value PreSET, so that the switching frequency does not exceed the predetermined switching frequency.

The storage circuit 310 stores information indicating the set value M.

### Operation of Switching Control Circuit 203c, When Inductor Current ILa, ILb Reaches Zero the Predetermined Number of Times

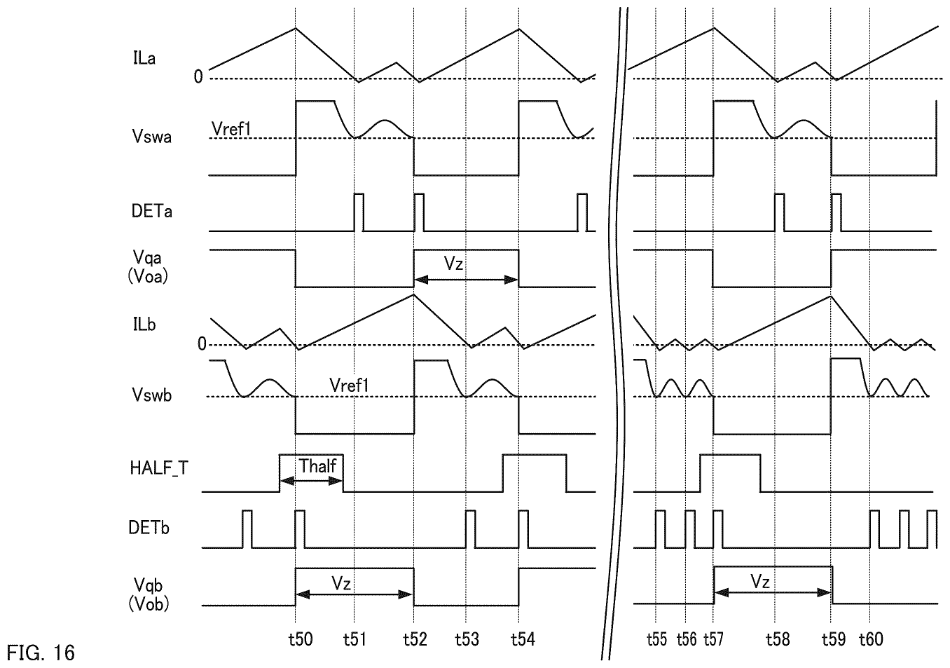

FIG. 16 is a diagram illustrating an operation example of a switching control circuit 203c. Note that the time period from time t50 to t54 indicates the operation when the NMOS transistors 26a, 26b are turned on in response to the inductor currents ILa, ILb reaching zero twice (i.e., the predetermined value M has been set to “2”). Meanwhile, the time period from time t55 indicates the operation when the timing at which the inductor current ILb reaches zero twice shifts from the half period Th. In this case, the rectified voltage Vrec is lowered.

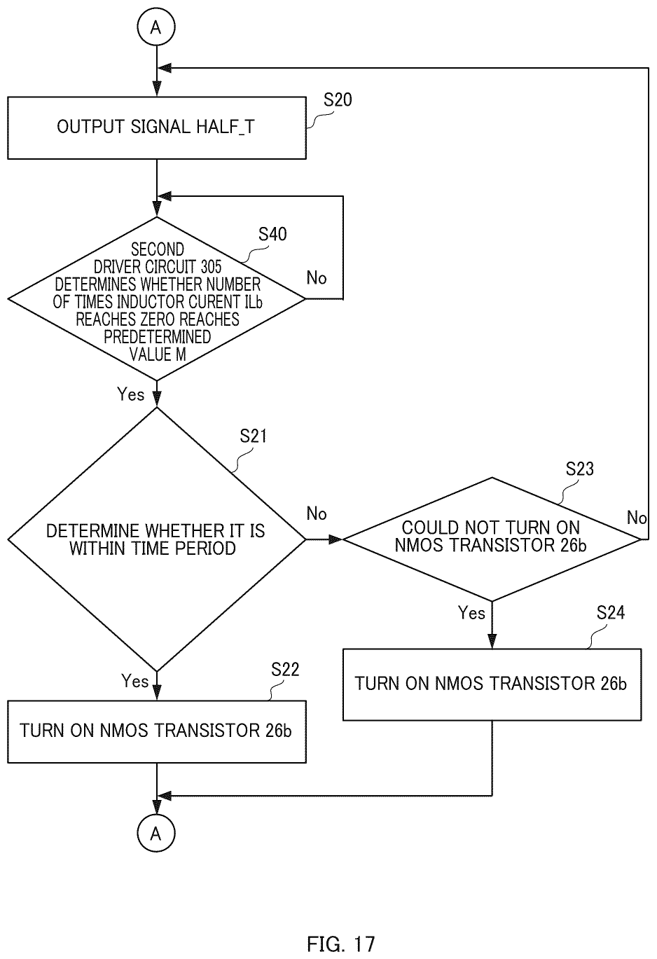

Before time t50, the NMOS transistor 26a is turned on, and at time t50, at which the ON period Vz has elapsed, the NMOS transistor 26a is turned off. Thus, the voltage Vzcda exceeds the reference voltage Vref1, and the inductor current ILa starts to decrease. Further, the output circuit 304 is outputting the high signal HALF_T (step S20 in FIG. 17).

Meanwhile, the NMOS transistor 26b has been turned off before time t50, and the inductor current ILb decreases and reaches zero for the second time. Thus, the detection circuit 303 outputs the high signal DETb. Then, the counter 308 counts the number of times the inductor current ILb reaches zero, as twice, and the count value of the counter 308 results in being equal to the set value M (step S40 in FIG. 17). Further, time t50 is the timing corresponding to the half period Th, and the output circuit 304 is outputting the high signal HALF_T (YES in step S21 in FIG. 17), and thus the second driver circuit 305 outputs the drive signal Vqb to turn on the NMOS transistor 26b (step S22 in FIG. 17). Then, the voltage Vzcdb drops below the reference voltage Vref1, and the inductor current ILb starts to increase.

At time t51, the inductor current ILa reaches zero for the first time. Thus, the detection circuit 301 outputs the high signal DETa. Then, the counter 307 counts the number of times the inductor current ILa reaches zero, as once, and the count value of the counter 307 is not equal to the set value M, and thus the first driver circuit 302 does not turn on the NMOS transistor 26a.

At time t52, at which the ON period Vz has elapsed since time t50, the NMOS transistor 26b is turned off and the inductor current ILb starts to decrease. Meanwhile, the inductor current ILa decreases and reaches zero for the second time. Thus, the detection circuit 301 outputs the high signal DETa. Then, the counter 307 counts the number of times the inductor current ILa reaches zero, as twice, and the count value of the counter 307 results in being equal to the set value M. Thus, the first driver circuit 302 turns on the NMOS transistor 26a.

At time t53, the inductor current ILb reaches zero for the first time. Thus, the detection circuit 303 outputs the high signal DETb. Then, the counter 308 counts the number of times the inductor current ILb reaches zero, as once, and the count value of the counter 308 is not equal to the set value M, and thus the second driver circuit 305 does not turn on the NMOS transistor 26b (step S40 in FIG. 17). Then, the same operation is repeated from time t54.

As such, in response to the inductor current ILb reaching zero for the second time during the time period during which the output circuit 304 is outputting the high signal HALF_T, the second driver circuit 305 outputs the drive signal Vqb to turn on the NMOS transistor 26b. Thus, the phase difference between the timings at which the NMOS transistors 26a, 26b are turned on is likely to be constant.

Further, the case in which the rectified voltage Vrec fluctuates low has been described here, however, when the rectified voltage Vrec fluctuates high, the timing at which the count value of the counter 308 becomes equal to the set value M may be delayed with respect to the time period during which the signal HALF_T is high, and may fall within the time period during which the signal HALF_T is low. In other words, while the output circuit 304 is outputting the low signal HALF_T, the count value of the counter 308 becomes equal to the set value M (NO in step S21 in FIG. 17).

In this case, when the number of times the NMOS transistor 26b has not been able to be turned on is less than the predetermined times N (NO in step S23 in FIG. 17), the second driver circuit 305 waits until the output circuit 304 outputs the high signal HALF_T (step S20 in FIG. 17). Meanwhile, when the number of times the second driver circuit 305 has not been able to turn on the NMOS transistor 26b reaches the predetermined number N (YES in step S23 in FIG. 17), the second driver circuit 305 turns on the NMOS transistor 26b at the timing at which the output circuit 304 outputs the signal HALF_T next (step S24 in FIG. 17).

In the above, the case has been described in which the count value of the counter 308 becomes equal to the set value M while the output circuit 304 is outputting the high signal HALF_T. The following describes the case in which while the output circuit 304 is outputting the low signal HALF_T, the count value of the counter 308 becomes equal to the set value M.

Before time t55, the NMOS transistor 26b is turned off, and at time t55, at which the inductor current ILb reaches zero for the first time, the detection circuit 303 outputs the high signal DETb. Then, the counter 308 counts the number of times the inductor current ILb reaches zero, as once, but the count value of the counter 308 is not equal to the set value M (NO in step S40 in FIG. 17). Thus, the second driver circuit 305 does not output the drive signal Vqb to turn on the NMOS transistor 26b.

At time t56 at which the inductor current ILb reaches zero for the second time, the detection circuit 303 outputs the high signal DETb. Then, the counter 308 counts the number of times the inductor current ILb reaches zero, as twice, and the count value of the counter 308 results in being equal to the set value M (YES in step S40 in FIG. 17). However, the output circuit 304 is outputting the low signal HALF_T, and thus the second driver circuit 305 does not output the drive signal Vqb to turn on the NMOS transistor 26b (NO in step S21 and NO in S23 in FIG. 17).

At time t57, at which the inductor current ILb reaches zero for the third time, the detection circuit 303 outputs the high signal DETb. Then, the counter 308 counts the number of times the inductor current ILb reaches zero, as three times, and the count value of the counter 308 exceeds the set value M. Then, the output circuit 304 is outputting the high signal HALF_T, and thus the second driver circuit 305 outputs the drive signal Vqb to turn on the NMOS transistor 26b (YES in steps S21, S22 in FIG. 17).

At time t58, the inductor current ILa reaches zero for the first time. Thus, the detection circuit 301 outputs the high signal DETa. Then, the counter 307 counts the number of times the inductor current ILa reaches zero, as once, and the count value of the counter 307 is not equal to the set value M, and thus the first driver circuit 302 does not turn on the NMOS transistor 26a.

At time t59, at which the ON period Vz has elapsed since time t57, the second driver circuit 305 outputs the drive signal Vqb to turn off the NMOS transistor 26b. Thereafter, the inductor current ILb starts to decrease. The same operation is repeated from time t60.

As such, even if the counter 308 counts the number of times the inductor current ILb reaches zero such that the number of times is equal to the set value M, the second driver circuit 305 does not output the drive signal Vqb to turn on the NMOS transistor 26b, when the output circuit 304 is outputting the low signal HALF_T. Thereafter, in response to the inductor current ILb reaching zero while the output circuit 304 is outputting the high signal HALF_T, the second driver circuit 305 outputs the drive signal Vqb to turn on the NMOS transistor 26b. Thus, the phase difference in the timings at which the NMOS transistors 26a, 26b are turned on is likely to be constant.

### Configuration of Switching Control Circuit 203d

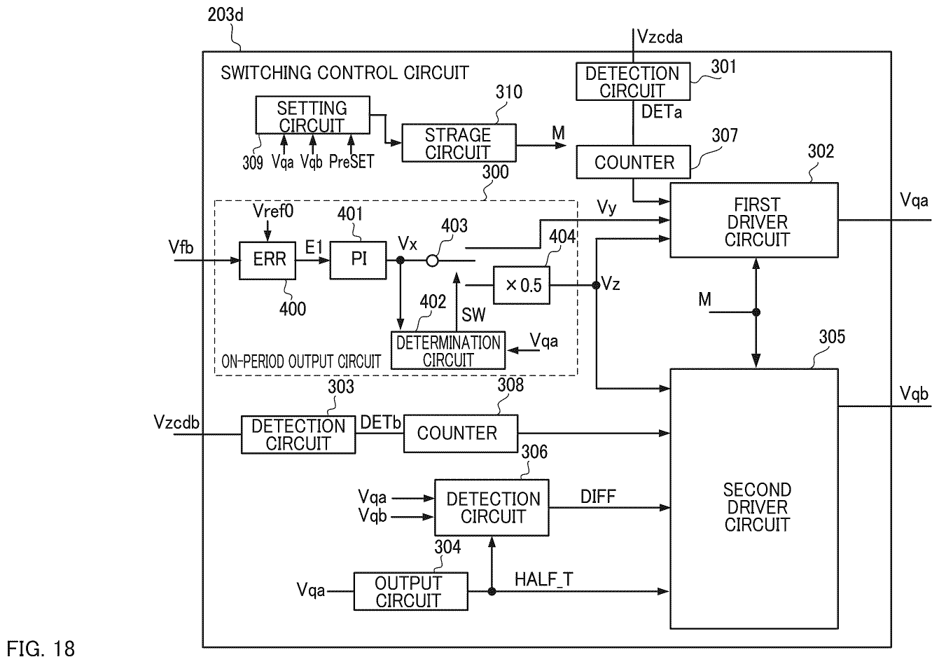

FIG. 18 is an example of a switching control circuit 203d, which is an embodiment of the switching control circuit 203. The switching control circuit 203d turns on the NMOS transistor 26b in the half period Th, in response to the difference between the half period Th and the phase difference in the switching timing becoming equal to or greater than a predetermined value, and turns on each of the NMOS transistor 26a, 26b, in response to the number of times the inductor current ILa, ILb reaches zero reaching the set value M.

The switching control circuit 203d includes the ON-period output circuit 300, the detection circuits 301, 303, 306, the first driver circuit 302, the output circuit 304, the second driver circuit 305, the counters 307, 308, the setting circuit 309, and the storage circuit 310.

### Operation of Switching Control Circuit 203d When Difference ΔT is Less Than Predetermined Value T0 and Inductor Current ILa, ILb Reaches Zero Predetermined Number of Times

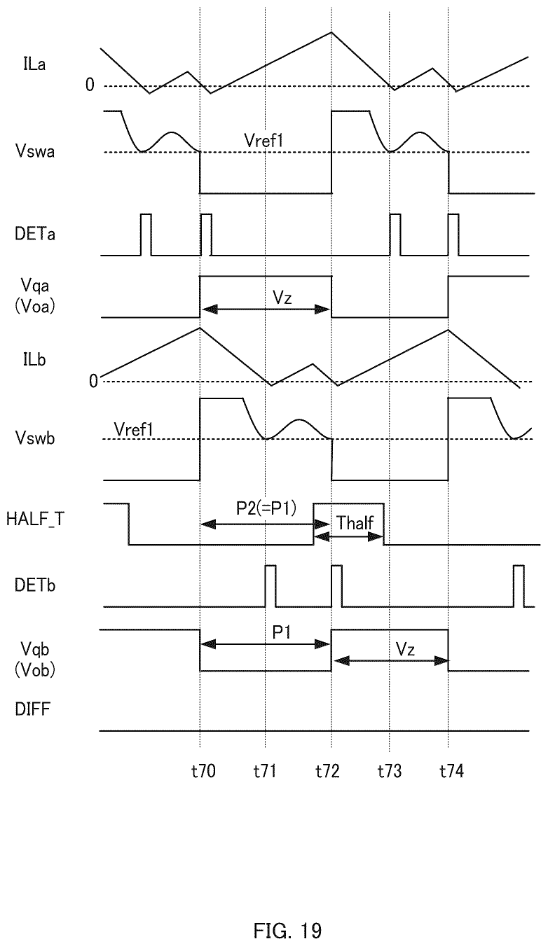

FIG. 19 is a diagram illustrating an operation example of the switching control circuit 203d. It is assumed that the NMOS transistors 26a, 26b are operating with the ON period Vz with which the NMOS transistors 26a, 26b are on in a half of the switching period. Further, it is assumed that the set value M is set to “2”.

Before time t70, the NMOS transistor 26a is turned off, and at time t70, at which the inductor current ILa reaches zero for the second time, the NMOS transistor 26a is turned on. Thus, the voltage Vzcda drops below the reference voltage Vref1, and the inductor current ILa starts to increase. Then, before time t70, the NMOS transistor 26b is turned on, and the ON period Vz has elapsed, and thus the NMOS transistor 26b is turned off. Then, the inductor current ILb starts to decrease.

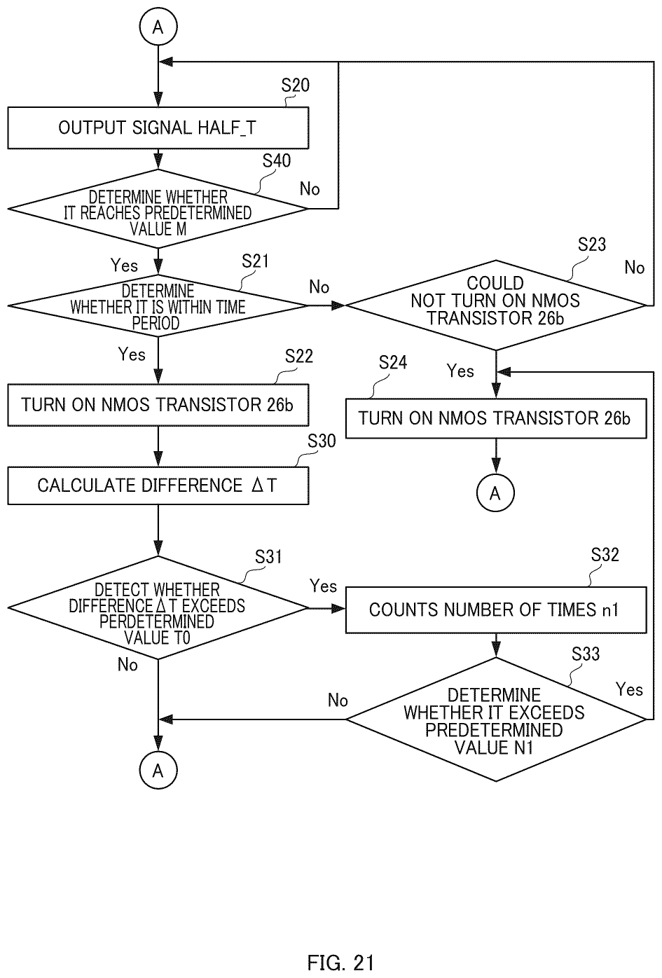

At time t71, the inductor current ILb decreases and reaches zero for the first time. Thus, the detection circuit 303 outputs the high signal DETb. Then, the counter 308 counts the number of times the inductor current ILb reaches zero, as once, and the count value of the counter 308 is not equal to the set value M (NO in step S40 in FIG. 21). Thus, the second driver circuit 305 does not output the drive signal Vqb to turn on the NMOS transistor 26b.

At time t72, the inductor current ILb decreases and reaches zero for the second time. Thus, the detection circuit 303 outputs the high signal DETb. Then, the counter 308 counts the number of times the inductor current ILb reaches zero, as twice, and the count value of the counter 308 results in being equal to the set value M (YES in step S40 in FIG. 21). Further, time t72 is the timing corresponding to the half cycle Th, and the output circuit 304 is outputting the high signal HALF_T (in step S20, YES in step S21 in FIG. 21), and thus the second driver circuit 305 turns on the NMOS transistor 26b (step S22 in FIG. 21). Then, the voltage Vzcdb drops below the reference voltage Vref1, and the inductor current ILb starts to increase. Note that the detection circuit 306 calculates the difference ΔT (step S30 in FIG. 21), and the difference ΔT is smaller than the predetermined value T0 (NO in step S31 in FIG. 21).

Meanwhile, the ON period Vz has elapsed since time t70, and thus the first driver circuit 302 outputs the drive signal Vqa to turn off the NMOS transistor 26a. Thus, the voltage Vzcda exceeds the reference voltage Vref1, and the inductor current ILa starts to decrease.

At time t73, the inductor current ILa reaches zero for the first time, after turning on of the NMOS transistor 26a. Thus, the detection circuit 301 outputs the high signal DETa. Then, the counter 307 counts the number of times the inductor current ILa reaches zero, as once, and the count value of the counter 307 is not equal to the set value M, and thus the first driver circuit 302 does not turn on the NMOS transistor 26a.

At time t74, at which the ON period Vz has elapsed since time t72, the NMOS transistor 26b is turned off and the inductor current ILb starts to decrease. Meanwhile, the inductor current ILa decreases and reaches zero for the second time. Thus, the detection circuit 301 outputs the high signal DETa. Then, the counter 307 counts the number of times the inductor current ILa reaches zero, as twice, and the count value of the counter 307 results in being equal to the set value M. Thus, the first driver circuit 302 turns on the NMOS transistor 26a. Hereinafter, the same operation will be repeated.

### Operation of Switching Control Circuit 203d When Difference ΔT is Predetermined Value T0 or More and Inductor Current ILa, ILb Reach Zero Predetermined Number of Times

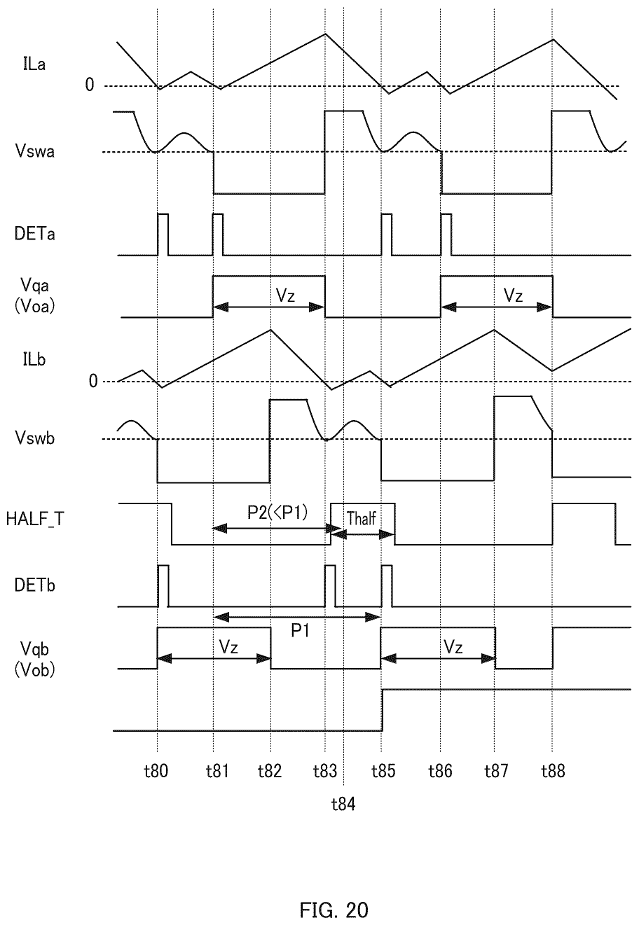

FIG. 20 is a diagram illustrating an operation example of the switching control circuit 203d. It is assumed that the set value M is set to “2”.

At time t80, the inductor current ILb reaches zero for the second time. Thus, the detection circuit 303 outputs the high signal DETb. Then, the counter 308 counts the number of times the inductor current ILb reaches zero, as twice, and the count value of the counter 308 results in being equal to the set value M (YES in step S40 in FIG. 21). Further, the output circuit 304 outputs the high signal HALF_T (in step S20, YES in step S21 in FIG. 21), the second driver circuit 305 turns on the NMOS transistor 26b (step S22 in FIG. 21). Thus, the voltage Vzcdb drops below the reference voltage Vref1, and the inductor current ILb starts to increase. Further, the inductor current ILa reaches zero for the first time after turning on of the NMOS transistor 26a. Thus, the detection circuit 301 outputs the high signal DETa. Then, the counter 307 counts the number of times the inductor current ILa reaches zero, as once, and the count value of the counter 307 is not equal to the set value M, and thus the first driver circuit 302 does not turn on the NMOS transistor 26a.

At time t81, in response to the inductor current ILa reaching zero for the second time and the detection circuit 301 outputting the high signal DETa, the first driver circuit 302 turns on the NMOS transistor 26a.

At time t82, at which the ON period Vz has elapsed since time t80, the second driver circuit 305 turns off the NMOS transistor 26b. Thus, the voltage Vzcdb exceeds the reference voltage Vref1, and the inductor current ILb starts to decrease.

At time t83, at which the ON period Vz has elapsed since time t81, the first driver circuit 302 turns off the NMOS transistor 26a. Thus, the voltage Vzcda exceeds the reference voltage Vref1, and the inductor current ILa starts to decrease. Then, the inductor current ILb reaches zero for the first time after turning on of the NMOS transistor 26b. Thus, the detection circuit 303 outputs the high signal DETb. Then, the counter 308 counts the number of times the inductor current ILb reaches zero, as once, and the count value of the counter 308 is not equal to the set value M (NO in step S40 in FIG. 21). Further, the output circuit 304 is outputting the low signal HALF_T, and thus the second driver circuit 305 does not turn on the NMOS transistor 26b.

At time t84, the output circuit 304 outputs the high signal HALF_T.

At time t85, at which the inductor current ILb reaches zero for the second time, the detection circuit 303 outputs the high signal DETb. Then, the counter 308 counts the number of times the inductor current ILb reaches zero, as twice, and the count value of the counter 308 results in being equal to the set value M (YES in step S40 in FIG. 21). Further, the output circuit 304 is outputting the high signal HALF_T (in step S20, YES in step S21 in FIG. 21), and thus the second driver circuit 305 turns on the NMOS transistor 26b (step S33 in FIG. 20). Further, the inductor current ILa reaches zero for the first time after turning on of the NMOS transistor 26a. Thus, the detection circuit 301 outputs the high signal DETa. Then, the counter 307 counts the number of times the inductor current ILa reaches zero, as once, and the count value of the counter 307 is not equal to the set value M, and thus the first driver circuit 302 does not turn on the NMOS transistor 26a.

In this case, the time period P2 is shorter than the time period P1, and thus the detection circuit 306 calculates the difference ΔT (step S30 in FIG. 21), and detects that the difference ΔT exceeds the predetermined value T0 (YES in step S31 in FIG. 21). Further, the detection circuit 306 counts the number of times n1, and outputs the high signal DIFF because the number of times n1 exceeds the predetermined number of times N1 (“0” in the case of the operation in FIG. 20) (YES in step S33 in FIG. 21).

At time t86, the inductor current ILa reaches zero for the second time after turning on of the NMOS transistor 26a. Thus, the detection circuit 301 outputs the high signal DETa. Then, the counter 307 counts the number of times the inductor current ILa reaches zero, as twice, and the count value of the counter 307 results in being equal to the set value M. Thus, the first driver circuit 302 turns on the NMOS transistor 26a.

At time t87, at which the ON period Vz has elapsed since time t85, the second driver circuit 305 turns off the NMOS transistor 26b. Thus, the voltage Vzcdb exceeds the reference voltage Vref1, and the inductor current ILb starts to decrease.

At time t88, in response to the output circuit 304 outputting the high signal HALF_T, the second driver circuit 305 turns on the NMOS transistor 26b (step S24 in FIG. 21).

As such, when the time periods P1 and P2 are not equal, the detection circuit 306 outputs the high signal DIFF because the difference ΔT between the half period Th and the phase difference in the switching between the NMOS transistors 26a, 26b exceeds the predetermined value T0. Then, the second driver circuit 305 turns on the NMOS transistor 26b in the half period Th.

When the operation is performed as such, in response to the difference ΔT exceeding the predetermined value T0, the NMOS transistor 26b is turned on in the half period Th, and thus the phase difference in the timing at which the NMOS transistors 26a, 26b are turned on is likely to be constant.

### SUMMARY

A description has been given of the AC-DC converter 10 according to an embodiment of the present disclosure. The switching control circuit 203a includes the first driver circuit 302, the output circuit 304, and the second driver circuit 305. The second driver circuit 305 turns on the NMOS transistor 26b, in response to the signal HALF_T from the output circuit 304 and the inductor current ILb reaching zero. This makes it possible to provide a switching control circuit that suppresses shift in phase difference even when the rectified voltage fluctuates during the interleaved operation.

Further, the second driver circuit 305 turns on the NMOS transistor 26b, in response to the inductor current ILb reaching zero in the time period during which the output circuit 304 is outputting the high signal HALF_T. This makes it possible to suppress shift in the phase difference caused by an early drop in the inductor current ILb due to a drop caused by fluctuations in the rectified voltage Vrec.

Further, the switching control circuit 203b includes the detection circuit 306, and the second driver circuit 305 turns on the NMOS transistor 26b, in response to the output circuit 304 outputting the high signal HALF_T when the difference ΔT exceeds the predetermined value T0. In other words, when the difference ΔT increases, the shift in the phase difference increases, and thus, in order to suppress the shift in the phase difference, the NMOS transistor 26b is turned on at the timing corresponding to the half period. This makes it possible to compensate for a variation in the switching period in association with the drop in the rectified voltage Vrec.

Further, the detection circuit 306 counts the number of times the difference ΔT exceeds the predetermined value T0, and when the count value exceeds the predetermined value T1, the second driver circuit 305 turns on the NMOS transistor 26b, in response to the output circuit 304 outputting the high signal HALF_T. As a result, when the state in which the difference ΔT exceeds the predetermined value T0 continues, the phase difference is corrected, thereby increasing the stability of the operation of the AC-DC converter 10.

Further, the switching control circuit 203c includes the counters 307, 308 and the storage circuit 310. Then, the first driver circuit 302 and the second driver circuit 305 perform a so-called bottom skip operation of turning on each of the NMOS transistors 26a, 26b, after passing through, the same number of times, a so-called bottom at which the voltage corresponding to each of the inductor currents ILa, ILb reaches the minimum value. This makes it possible to suppress harmonic distortion of the input current caused by a rise in the switching frequency of the NMOS transistor 26a, 26b.

Further, the switching control circuit 203c includes the setting circuit 309. This enables the switching control circuit 203c to flexibly set the number of times of the bottom, based on the switching period as well, with the predetermined set value PreSET set by a user as the minimum value.

The present disclosure is directed to provision of switching control circuit that suppresses shift in phase difference even when a rectified voltage fluctuates during an interleaving operation.

According to the present disclosure, it is possible to provide a switching control circuit that suppresses shift in phase difference even when a rectified voltage fluctuates during an interleaving operation.

Embodiments of the present disclosure described above are simply to facilitate understanding of the present disclosure and is not in any way to be construed as limiting the present disclosure. The present disclosure may variously be changed or altered without departing from its essential features and encompass equivalents thereof.

What is claimed is:

1. A switching control circuit for a power supply circuit, the power supply circuit including
a first circuit that includes:
a first inductor configured to receive a voltage corresponding to an alternating current (AC) voltage, and
a first transistor configured to control a first inductor current flowing through the first inductor,
a second circuit that includes:
a second inductor configured to receive the voltage corresponding to the AC voltage, and
a second transistor configured to control a second inductor current flowing through the second inductor, and
an output terminal to which the first circuit,
the second circuit, and a load are connected,
the power supply circuit being configured to generate an output voltage of a target level at the output terminal from the AC voltage inputted thereto,
the switching control circuit being configured to control switching of the first transistor and the second transistor, the switching control circuit comprising:
a first driver circuit configured to turn off the first transistor, in response to a first time period corresponding to the output voltage having elapsed since the first transistor has been turned on after the first inductor current reaches a first value;
an output circuit configured to output a signal indicating a half period of a switching period of the first transistor; and
a second driver circuit configured to
turn on the second transistor, in response to the signal indicating the half period after turning on of the first transistor, and the second inductor current reaching a second value, and
turn off the second transistor, in response to a second time period corresponding to the output voltage having elapsed.

2. The switching control circuit according to claim 1, wherein the second driver circuit turns on the second transistor, in response to the second inductor current reaching the second value in a predetermined time period determined by a timing of the half period after turning on of the first transistor.

3. The switching control circuit according to claim 2, further comprising:
a detection circuit configured to detect whether a difference between
the half period, and
a first difference between a first timing at which the first transistor is switched and a second timing at which the second transistor is switched,
exceeds a first predetermined value, wherein
the second driver circuit turns on the second transistor, in response to the half period having elapsed after turning on of the first transistor, based on a detection result indicating that said difference exceeds the first predetermined value.

4. The switching control circuit according to claim 3, wherein
the detection circuit counts a number of times said difference exceeds the first predetermined value, and
the second driver circuit turns on the second transistor, in response to the half period having elapsed after turning on of the first transistor, when a count value of the detection circuit exceeds a second predetermined value.

5. The switching control circuit according to claim 2, further comprising:
a first counter configured to count a number of times the first inductor current reaches the first value;
a second counter configured to count a number of times the second inductor current reaches the second value; and
a storage circuit configured to store information indicating a set value, wherein
the first driver circuit turns on the first transistor, in response to a count value of the first counter reaching the set value, and
the second driver circuit turns on the second transistor, in response to a count value of the second counter reaching the set value in the predetermined time period.

6. The switching control circuit according to claim 5, further comprising:
a setting circuit configured to set the set value, based on a predetermined set value and a predetermined switching frequency of each of the first transistor and the second transistor.

7. The switching control circuit according to claim 1, wherein the second time period is equal to the first time period.

8. A power supply circuit configured to generate an output voltage at a target level from an alternating current (AC) voltage inputted thereto, the power supply circuit comprising:
a first circuit that includes:
a first inductor configured to receive a voltage corresponding to the AC voltage, and
a first transistor configured to control a first inductor current flowing through the first inductor;
a second circuit that includes:
a second inductor configured to receive the voltage corresponding to the AC voltage, and
a second transistor configured to control a second inductor current flowing through the second inductor;
an output terminal to which the first circuit, the second circuit, and a load are connected, and through which the generated output voltage is outputted; and
a switching control circuit configured to control switching of the first transistor and the second transistor, the switching control circuit including
a first driver circuit configured to turn off the first transistor, in response to a first time period corresponding to the output voltage having elapsed since the first transistor has been turned on after the first inductor current reaches a first value,
an output circuit configured to output a signal indicating a half period of a switching period of the first transistor, and
a second driver circuit configured to
turn on the second transistor, in response to the signal indicating the half period after turning on of the first transistor, and the second inductor current reaching a second value, and
turn off the second transistor, in response to a second time period corresponding to the output voltage having elapsed.
